(19) United States
(12) Patent Application Publication
(10) Pub. No.: US 2024/0172072 A1
(43) Pub. Date: May 23, 2024

(54) METHOD AND APPARATUS FOR SUPPORTING FAST RADIO QUALITY-ADAPTIVE INTER-CELL MOBILITY

(71) Applicant: ELECTRONICS AND TELECOMMUNICATIONS RESEARCH INSTITUTE, Daejeon (KR)

(72) Inventors: Soon Gi Park, Daejeon (KR); Jun Sik Kim, Daejeon (KR); Young Jo Ko, Daejeon (KR); Seok Bong Hyun, Daejeon (KR)

(21) Appl. No.: 18/517,659

(22) Filed: Nov. 22, 2023

(30) Foreign Application Priority Data
Nov. 22, 2022 (KR) 10-2022-0157206
Nov. 24, 2022 (KR) 10-2022-0159329
Feb. 16, 2023 (KR) 10-2023-0020448
Nov. 21, 2023 (KR) 10-2023-0162130

(51) Int. Cl. H04W 36/08; H04W 36/00

(52) U.S. Cl. CPC H04W 36/087; H04W 36/0016; H04W 36/0058

(57) ABSTRACT

A method of a first distributed unit (DU) may comprise: receiving a measurement report from a user equipment (UE) through a serving (S)-master cell group (MCG) of the first DU; transmitting a first message including the measurement report to a first central unit (CU); performing a configuration operation of a target (T)-MCG between the first DU and the first CU; and transmitting configuration information of the T-MCG for the first DU to the UE, wherein the T-MCG for the first DU is configured with the UE based on the configuration information of the T-MCG.

### CROSS-REFERENCE TO RELATED APPLICATIONS

This application claims priority to Korean Patent Applications No. 10-2022-0157206, filed on Nov. 22, 2022, No. 10-2022-0159329, filed on Nov. 24, 2022, No. 10-2023-0020448, filed on Feb. 16, 2022, and No. 10-2023-0162130, filed on Nov. 21, 2023, with the Korean Intellectual Property Office (KIPO), the entire contents of which are hereby incorporated by reference.

### BACKGROUND

### 1. Technical Field

Exemplary embodiments of the present disclosure relate to a technique for supporting mobility, and more specifically, to a technique for supporting mobility of a terminal under a situation where the terminal is connected to a plurality of cells.

### 2. Related Art

The communication system (e.g., a new radio (NR) communication system) using a higher frequency band (e.g., a frequency band of 6 GHz or above) than a frequency band (e.g., a frequency band of 6 GHz or below) of the long term evolution (LTE) communication system (or, LTE-A communication system) is being considered for processing of soaring wireless data. The NR system may support not only a frequency band of 6 GHz or below, but also a frequency band of 6 GHz or above, and may support various communication services and scenarios compared to the LTE system. In addition, requirements of the NR system may include enhanced Mobile BroadBand (eMBB), Ultra Reliable Low Latency Communication (URLLC), and Massive Machine Type Communication (mMTC).

Meanwhile, a terminal supporting dual connectivity (DC) can be connected to multiple cells. For example, the terminal may be connected to a primary cell (PCell) and/or a primary secondary cell (PSCell). The terminal may be connected to a master node (MN) SCell and/or a secondary node (SN) SCell. Cell change and/or cell addition may be required depending on mobility of the terminal. Alternatively, the terminal itself may request cell change and/or cell addition. In this case, a cell change operation and/or a cell addition operation may be performed. Methods for reducing delay, overhead, and/or interruption time during the cell change operation and/or the cell addition operation may be required. Moreover, it is important to develop methods that can minimize data transmission rate variability.

### SUMMARY

Exemplary embodiments of the present disclosure are directed to providing a method and an apparatus for supporting inter-cell mobility in a communication system supporting dual connectivity (DC).

According to a first exemplary embodiment of the present disclosure, a method of a first distributed unit (DU) may comprise: receiving a measurement report from a user equipment (UE) through a serving (S)-master cell group (MCG) of the first DU; transmitting a first message including the measurement report to a first central unit (CU); performing a configuration operation of a target (T)-MCG between the first DU and the first CU; and transmitting configuration information of the T-MCG for the first DU to the UE, wherein the T-MCG for the first DU is configured with the UE based on the configuration information of the T-MCG.

The first message may request to perform a pre-preparation procedure for an inter-cell mobility procedure, and in the pre-preparation procedure, the T-MCG for the first DU may be configured.

The performing of the configuration operation of the T-MCG between the first DU and the first CU may comprise: receiving, from the first CU, a second message indicating to perform a pre-preparation procedure for an inter-cell mobility procedure; and transmitting a third message in response to the second message to the first CU, wherein the T-MCG is configured by exchanging the second message and the third message, and at least one of the second message or the third message includes information element(s) required for configuring the T-MCG.

The transmitting of the configuration information of the T-MCG for the first DU to the UE may comprise: receiving, from the first CU, a fourth message including the configuration information of the T-MCG; and transmitting a first radio resource control (RRC) message including the configuration information of the T-MCG to the UE, wherein the first RRC message is an RRC connection reconfiguration message.

The method may further comprising: receiving, from the UE, a second RRC message indicating that the configuration of the T-MCG is complete; and transmitting, to the first CU, a fifth message indicating that the configuration of the T-MCG is completed, wherein the second RRC message is an RRC connection reconfiguration complete message.

The method may further comprise: in response to satisfying a triggering condition of an inter-cell mobility procedure, transmitting, to the UE, a first medium access control (MAC) control element (CE) indicating to perform the inter-cell mobility procedure; and receiving, from the UE, a second MAC CE indicating that the inter-cell mobility procedure is completed.

The first MAC CE may be transmitted through the S-MCG of the first DU, and the second MAC CE may be received through the T-MCG of the first DU.

The method may further comprise: in response to that the inter-cell mobility procedure is completed, transmitting, to the first CU, a sixth message including information on a result of the inter-cell mobility procedure.

According to a second exemplary embodiment of the present disclosure, a method of a first central unit (CU) may comprise: receiving a first message including a measurement report of a user equipment (UE) from a first distributed unit (DU) to which the UE is connected; performing a configuration operation of a target (T)-master cell group (MCG) between a second DU and the first CU; and transmitting configuration information of the T-MCG for the second DU to the UE through the first DU, wherein the T-MCG for the second DU is configured with the UE based on the configuration information of the T-MCG.

The first DU and the second DU may be connected to the first CU, and a cell to which the UE is connected may be changed from a cell of the first DU to a cell of the second DU by an inter-cell mobility procedure.

The first message may request to perform a pre-preparation procedure for an inter-cell mobility procedure, and in the pre-preparation procedure, the T-MCG for the second DU may be configured.

The performing of the configuration operation of the T-MCG between the second DU and the first CU may comprise: transmitting, to the second DU, a second message indicating to perform a pre-preparation procedure for an inter-cell mobility procedure; and receiving, from the second DU, a third message in response to the second message, wherein the T-MCG is configured by exchanging the second message and the third message, and at least one of the second message or the third message includes information element(s) required for configuring the T-MCG.

The transmitting of the configuration information of the T-MCG for the second DU to the UE through the first DU may comprise: transmitting a fourth message including the configuration information of the T-MCG to the first DU, wherein a first radio resource control (RRC) message including the configuration information of the T-MCG is transmitted from the first DU to the UE, and the first RRC message is an RRC connection reconfiguration message.

The method may further comprise: receiving, from the first DU, a fifth message indicating that the configuration of the T-MCG of the UE is completed.

The method may further comprise: receiving, from the first DU, a sixth message indicating that an inter-cell mobility procedure is completed; and receiving, from the second DU, a seventh message indicating that the inter-cell mobility procedure is completed, wherein the inter-cell mobility procedure is triggered by the first DU.

According to a third exemplary embodiment of the present disclosure, a method of a second central unit (CU) may comprise: receiving, from a first CU, a first message requesting to perform a pre-preparation procedure for an inter-cell mobility procedure; performing a configuration operation of a target (T)-master cell group (MCG) between a second DU and the second CU; and transmitting configuration information of the T-MCG for the second DU to the first CU, wherein the T-MCG for the second DU is configured with a user equipment (UE) based on the configuration information of the T-MCG.

The second DU may be connected to the second CU, the first DU may be connected to the first CU, and a cell to which the UE is connected may be changed by the inter-cell mobility procedure from a cell of the first DU to a cell of the second DU.

The performing of the configuration operation of the T-MCG between the second DU and the second CU may comprise: transmitting, to the second DU, a second message indicating to perform the pre-preparation procedure for the inter-cell mobility procedure; and receiving, from the second DU, a third message in response to the second message, wherein the T-MCG is configured by exchanging the second message and the third message, and at least one of the second message or the third message includes information element(s) required for configuring the T-MCG.

The method may further comprise: receiving, from the second DU, a fourth message indicating that the inter-cell mobility procedure is completed, wherein the inter-cell mobility procedure is triggered by the first DU.

The method may further comprise: transmitting, to the CN, a fifth message requesting switching from a path between a core network (CN) and the first CU to a path between the CN and the second CU; and receiving, from the CN, a sixth message in response to the sixth message.

According to the present disclosure, smart dynamic switching (SDS) operations can be supported in various scenarios (e.g. scenarios for intra-CU and intra-DU, scenarios for intra-CU and inter-DU, scenarios for inter-CU and inter-DU). In this case, a delay, overhead, and/or interruption time for a mobility procedure can be reduced. Additionally, fluctuations in data transmission rates can be reduced. Accordingly, the performance of the communication system can be improved.

### BRIEF DESCRIPTION OF DRAWINGS

FIG. 1 is a conceptual diagram illustrating a CU/DU network.

FIG. 2 is a conceptual diagram illustrating categories of FSDM.

FIG. 3 is a conceptual diagram illustrating a movement path of a UE across cell groups (CellGs).

FIG. 4 is a conceptual diagram illustrating a quality measurement model.

FIG. 5A is a conceptual diagram illustrating an exemplary embodiment of a reconfiguration range (or reuse range) in Case A of FIG. 1.

FIG. 5B is a conceptual diagram illustrating an exemplary embodiment of a reconfiguration range (or reuse range) in Case B of FIG. 1.

FIG. 5C is a conceptual diagram illustrating an exemplary embodiment of a reconfiguration range (or reuse range) in Case C of FIG. 1.

FIG. 6 is a conceptual diagram illustrating a control plane (CP) in a single PCell operation scheme.

FIGS. 7A to 7E are conceptual diagrams illustrating possible states in each of source (S)-MN and target (T)-MN.

FIG. 8A is a conceptual diagram illustrating a vertical mobility procedure under a CA situation.

FIG. 8B is a conceptual diagram illustrating a horizontal mobility procedure under a CA situation.

FIG. 8C is a conceptual diagram illustrating a dual SpCell horizontal mobility procedure under a CA situation.

FIGS. 9A to 9C are conceptual diagrams illustrating a method of sharing information among entities belonging to NW.

FIG. 10A is a sequence chart illustrating a first exemplary embodiment of a method for acquiring a TA.

FIG. 10B is a sequence chart illustrating a second exemplary embodiment of a method for acquiring a TA.

FIGS. 11A to 11I are conceptual diagrams illustrating exemplary embodiments of a structure and transmission of a MAC CE.

FIGS. 11J to 11L are conceptual diagrams illustrating other exemplary embodiments of the L1/L2 MAC CE 1.

FIGS. 11M to 11O are conceptual diagrams illustrating other exemplary embodiments of the L1/L2 MAC CE 2.

FIG. 12A is a sequence chart illustrating a PP1-1 procedure in Case A of FIG. 1.

FIG. 12B is a sequence chart illustrating a PP2 procedure in Case A of FIG. 1.

FIG. 13A is a sequence chart illustrating a PP1-1 procedure in Case B of FIG. 1.

FIG. 13B is a sequence chart illustrating a PP2 procedure in Case B of FIG. 1.

FIG. 14A is a sequence chart illustrating a PP1-1 procedure in Case C of FIG. 1.

FIG. 14B is a sequence chart illustrating a PP3 procedure in Case C of FIG. 1.

FIG. 15 is a conceptual diagram illustrating examples of states in each case.

FIG. 16A is a conceptual diagram illustrating State A in Case A in terms of UP.

FIG. 16B is a conceptual diagram illustrating State B in Case A in terms of UP.

FIG. 16C is a conceptual diagram illustrating State C in Case A in terms of UP.

FIG. 16D is a conceptual diagram illustrating State D in Case A in terms of UP.

FIG. 16E is a conceptual diagram illustrating State A′ in Case A in terms of UP.

FIG. 16F is a conceptual diagram illustrating State B′ in Case A in terms of UP.

FIG. 16G is a conceptual diagram illustrating State C′ in Case A in terms of UP.

FIG. 16H is a conceptual diagram illustrating State D′ in Case A in terms of UP.

FIG. 17A is a conceptual diagram illustrating State A in Case B in terms of UP.

FIG. 17B is a conceptual diagram illustrating State B in Case B in terms of UP.

FIG. 17C is a conceptual diagram illustrating State C in Case B in terms of UP.

FIG. 17D is a conceptual diagram illustrating State D in Case B in terms of UP.

FIG. 17E is a conceptual diagram illustrating State A′ in Case B in terms of UP.

FIG. 17F is a conceptual diagram illustrating State B′ in Case B in terms of UP.

FIG. 17G is a conceptual diagram illustrating State C′ in Case B in terms of UP.

FIG. 17H is a conceptual diagram illustrating State D′ in Case B in terms of UP.

FIG. 18A is a conceptual diagram illustrating State A in Case C in terms of UP.

FIG. 18B is a conceptual diagram illustrating State B in Case C in terms of UP.

FIG. 18C is a conceptual diagram illustrating State C in Case C in terms of UP.

FIG. 18D is a conceptual diagram illustrating State D in Case C in terms of UP.

FIG. 18E is a conceptual diagram illustrating State A′ in Case C in terms of UP.

FIG. 18F is a conceptual diagram illustrating State B′ in Case C in terms of UP.

FIG. 18G is a conceptual diagram illustrating State C′ in Case C in terms of UP.

FIG. 18H is a conceptual diagram illustrating State D′ in Case C in terms of UP.

FIG. 19 is a conceptual diagram illustrating a first exemplary embodiment of a CP according to a preparation procedure in Case C.

FIG. 20 is a conceptual diagram illustrating a second exemplary embodiment of a CP according to a preparation procedure in Case C.

FIG. 21 is a conceptual diagram illustrating an L1/L2 MCG list and an L1/L2 SCG list.

FIGS. 22A to 22D are conceptual diagrams illustrating other exemplary embodiments of the L1/L2 MAC CE 1.

FIGS. 22E to 22H are conceptual diagrams illustrating other exemplary embodiments of the L1/L2 MAC CE 2.

FIG. 23 is a block diagram illustrating a communication node constituting a communication system.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system may be the 4G communication system (e.g., Long-Term Evolution (LTE) communication system or LTE-A communication system), the 5G communication system (e.g., New Radio (NR) communication system), the sixth generation (6G) communication system, or the like. The 4G communication system may support communications in a frequency band of 6 GHz or below, and the 5G communication system may support communications in a frequency band of 6 GHz or above as well as the frequency band of 6 GHz or below. The communication network may include a terrestrial network and a non-terrestrial network. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

In exemplary embodiments, “an operation (e.g., transmission operation) is configured” may mean that “configuration information (e.g., information element(s) or parameter(s)) for the operation and/or information indicating to perform the operation is signaled”. “Information element(s) (e.g., parameter(s)) are configured” may mean that “corresponding information element(s) are signaled”. In other words, “an operation (e.g., transmission operation) is configured in a communication node” may mean that the communication node receives “configuration information (e.g., information elements, parameters) for the operation” and/or “information indicating to perform the operation”. “An information element (e.g. parameter) is configured in a communication node” may mean that “the information element is signaled to the communication node (e.g. the communication node receives the information element)”.

The signaling may be at least one of system information (SI) signaling (e.g., transmission of system information block (SIB) and/or master information block (MIB)), RRC signaling (e.g., transmission of RRC parameters and/or higher layer parameters), MAC control element (CE) signaling, or PHY signaling (e.g., transmission of downlink control information (DCI), uplink control information (UCI), and/or sidelink control information (SCI)). A signaling message may be at least one of an SI signaling message (e.g., SI message), an RRC signaling message (e.g., RRC message), a MAC CE signaling message (e.g., MAC CE message or MAC message), or a PHY signaling message (e.g., PHY message).

Hereinafter, even when a method (e.g., transmission or reception of a signal) performed at a first communication node among communication nodes is described, a corresponding second communication node may perform a method (e.g., reception or transmission of the signal) corresponding to the method performed at the first communication node. That is, when an operation of a terminal is described, a base station corresponding to the terminal may perform an operation corresponding to the operation of the terminal. Conversely, when an operation of a base station is described, a terminal corresponding to the base station may perform an operation corresponding to the operation of the base station. In addition, when an operation of a first terminal is described, a second terminal corresponding to the first terminal may perform an operation corresponding to the operation of the first terminal. Conversely, when an operation of a second terminal is described, a first terminal corresponding to the second terminal may perform an operation corresponding to the operation of the second terminal.

Meanwhile, reconfiguration including synchronization for change of a special cell (SpCell) (e.g. a primary cell (PCell) and a primary secondary cell (PSCell)) may be performed through RRC signaling (e.g. L3 signaling). A trigger for changing a serving cell may be based on L3 measurements. Reconfiguration including synchronization for release and addition of secondary cells (SCells) may be performed through RRC signaling (e.g. L3 signaling).

During a handover execution step, L1/L2 configurations may always be reset, and the resetting of the L1/L2 configurations may cause a delay, overhead, and/or interruption time. A long delay, large overhead, and/or long interruption time may be a big problem in an ultra-dense network (UDN). The UDN may be a network to be selected to improve capacity of an area. As a higher frequency (e.g. mmWave or THz) is used, a UDN may be formed, a cell dwelling time in the UDN may be reduced, and thus frequent cell changes may occur. In terms of the communication system, the total interruption time may become even longer. Due to the high frequency, narrow beams may be used, and channel variation may increase due to the use of narrow beams. In addition, coverage holes may occur. Due to the above-described problems, when an RRC reconfiguration operation is performed, the total interruption time may become longer.

L1/L2-based mobility can be provided in an intra-distributed unit (DU) scenario, inter-DU scenario, intra-central unit (CU) scenario, and/or intra-base station (BS) scenario. In this case, the delay, overhead, and/or interruption time can be reduced.

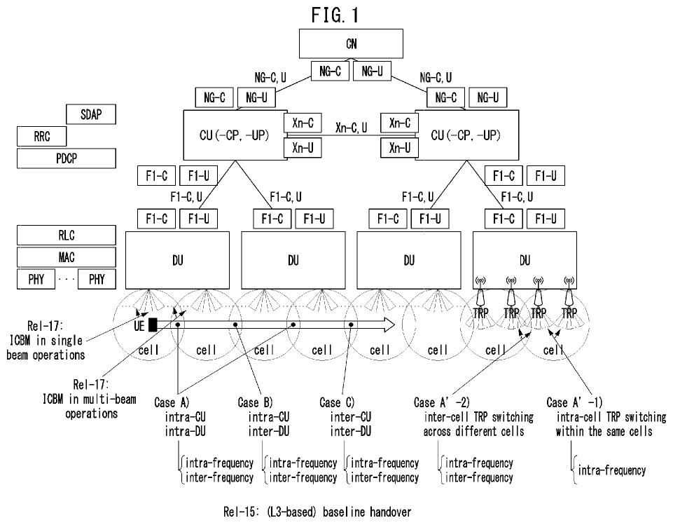

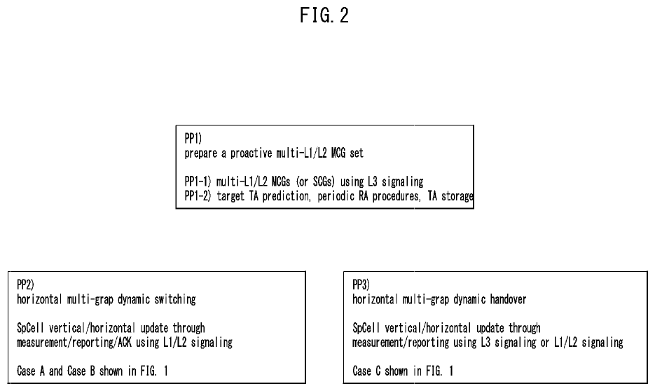

FIG. 1 is a conceptual diagram illustrating a CU/DU network.

Referring to FIG. 1, three cases for a CU/DU network may be defined. The three cases may include Case A, Case B, and Case C. Case A, Case B, and Case C may be defined as follows. An inter-cell mobility procedure may be performed in each case.
Case A: Intra-CU, Intra-DU
Case B: Intra-CU, Inter-DU
Case C: Inter-CU, Inter-DU

Additional cases, Case A′-1 and Case A′-2, may be defined as follows.
Case A′-1: Intra-cell transmission and reception point (TRP) switching within the same cell
Case A′-2: Inter-cell TRP switching across different cells

The inter-cell mobility procedure may comprise an L3 measurement/reporting step by L3 signaling, a handover preparation step, a handover execution step, and a handover completion step. In the present disclosure, extensions, modifications, and/or additions to the existing mechanisms and existing protocols may be performed, and the inter-cell mobility procedure may be performed using L1/L2 signaling (e.g. L1-downlink control information (DCI) and/or L2-medium access control (MAC) control element (CE)). In this case, a terminal can be quickly connected to a high quality cell. In the present disclosure, the existing mechanisms and existing protocols may be reused. For example, the inter-cell beam switching (ICBM) mechanism specified in 3GPP Rel-17 may be used in intra-cell beam switching and/or inter-cell beam switching. The intra-cell beam switching may be a beam selection operation within a cell. When the inter-cell beam switching is supported, communication (e.g. data transmission and reception operations) with another cell may be performed without changing a current serving cell. The baseline handover specified in 3GPP Rel-15 may be reused in a fast smart dynamic mobility (FSDM) proposed in the present disclosure. The L3 single procedure, multi-preparation procedure, and/or mechanism for operating two SpCells in the conditional handover (CHO), dual active protocol stack (DAPS), and/or multi-radio access technology (MR)-DC may be reused in the FSDM (e.g. smart dynamic mobility (SDM)) proposed in the present disclosure.

FIG. 2 is a conceptual diagram illustrating categories of FSDM.

Referring to FIG. 2, there may be three categories (e.g. PP1, PP2, PP3) for FSDM. The PP1 may be a preparation procedure before executing/completing the L1/L2 inter-cell mobility procedure. The PP1 may be divided into a PP1-1 and a PP1-2. The PP1-1 may be a preparation procedure for a set of proactive multiple L1/L2 master cell groups (MCGs). The preparation procedure for the set of proactive multiple L1/L2 MCGs (i.e., proactive multi-L1/L2 MCG set) may refer to a preliminary preparation (i.e. pre-preparation) procedure of the L1/L2 inter-cell mobility procedure. The pre-preparation procedure for the proactive multi-L1/L2 MCG set may be a procedure for sharing information on target candidate cell(s) between a network and a terminal (e.g. user equipment (UE)) based on a current serving cell. The pre-preparation procedure (e.g. pre-preparation step) may be a procedure (e.g. step) that is executed before execution/completion of the L1/L2 inter-cell mobility procedure (e.g. PP2 or PP3). A time for the pre-preparation step may not be included in an actual switching time. Therefore, the existing L3 signaling may be utilized for the pre-preparation step. A set of a serving cell group and a candidate cell group (e.g. target cell group) may be referred to as the L1/L2 MCG set.

The PP1-2 may be a horizontal multi-graps dynamic switching procedure. The horizontal multi-graps dynamic switching procedure may be performed to obtain timing advances (TAs) for candidate cells. The TAs may be acquired or estimated based on the following three schemes.
TA for each of other cells may be estimated based on an arrival time of an uplink signal and/or data in the current serving cell.
The TA(s) may be continuously updated by periodically performing random access channel (RACH) procedures for the candidate cell(s).
The TA for inter-cell mobility history may be stored, and in a procedure for switching to a target cell, if a TA of the target cell is stored in the inter-cell mobility history, the TA stored in the inter-cell mobility history may be used.

A vertical mobility procedure may refer to a procedure in which one PCell within a serving MCG (e.g. PCell, SCells) is changed to an SCell in the same location as the PCell under a carrier aggregation (CA) situation.

The PP2 may be a horizontal multi-graps dynamic switching procedure. The PP2 may be applied to Case A and Case B shown in FIG. 1. The inter-cell mobility procedure may be performed based on L1 measurement and L1/L2 signaling.

The PP3 may be a horizontal multi-graps dynamic handover procedure. The PP3 may be applied to Case C shown in FIG. 1. The inter-cell mobility procedure may be performed based on L1 measurement and L1/L2 signaling. Alternatively, the inter-cell mobility procedure may be performed based on L3 measurement and L3 signaling. The inter-cell mobility procedure based on L3 measurement and L3 signaling may be almost identical to the L3-based handover procedure.

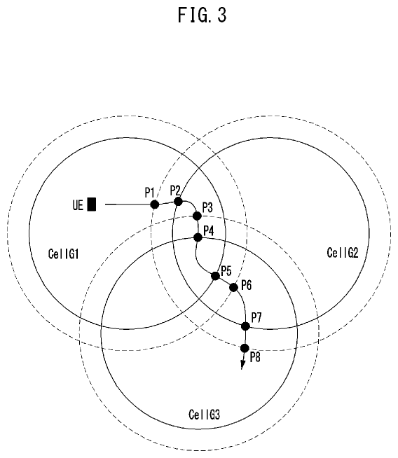

FIG. 3 is a conceptual diagram illustrating a movement path of a UE across cell groups (CellGs).

Referring to FIG. 3, a UE may move within three cell groups (e.g. CellG1, CellG2, CellG3). In addition, P1, P2, P3, P4, P5, P6, P7, and P8 may represent points along the UE's movement path. Each action of PP1, PP2, and PP3 according to the UE's movement path and standard impacts on a network (NW) and UE in each case according to the UE's movement path may be defined as Table 1 below. In Table 1 below, X may mean that there is no impact on the technical specifications. In other words, X may mean that no change is required in the operations specified in the technical specifications. In Table 1 below, O may mean that there are impacts on the technical specifications. In other words, O may mean that changes are required in the operations specified in the technical specifications. The impacts on the NW technical specifications may mean impacts on NG-C/U, Xn-C/U, and/or F1-C/U. The impacts on the UE technical specifications may mean impacts on radio (e.g. physical downlink control channel (PDCCH), DCI, MAC CE, radio resource control (RRC)) between NW and UE.

TABLE 1

| Point/segment | Action | Case A | Case B | Case C |
|---|---|---|---|---|
| P1 | PP1-1 CellG2 (CellG1/2) | NW: X | NW: O | NW: O |
| | PP1-2 to CellG2 (optional) | UE: O | UE: O | UE: O |
| P2-P3 | PP2 or PP3 among 2 CellGs (1/2) | NW: X | NW: O | NW: O |
| | PP1-2 to CellG2 (optional) | UE: O | UE: O | UE: O |
| P3 | PP1-1 CellG3 (CellG1/2/3) | NW: X | NW: O | NW: O |
| | PP1-2 to CellG 2/3 (optional) | UE: O | UE: O | UE: O |
| P3-P4 | PP2 or PP3 among 2 CellGs (1/2) | NW: X | NW: O | NW: O |
| | PP1-2 to CellG 1 or 2 (optional) | UE: O | UE: O | UE: O |
| P4-P5 | PP2 or PP3 among 3 CellGs (1/2/3) | NW: X | NW: O | NW: O |
| | PP1-2 to CellG2/3, CellG1/3, or | UE: O | UE: O | UE: O |
| | CellG1/2 (optional) | | | |
| P5-P6 | PP2 or PP3 among 2 CellGs (2/3) | NW: X | NW: O | NW: O |
| | PP1-2 to CellG2 or CellG3 (optional) | UE: O | UE: O | UE: O |
| P6 | PP1-1 CellG1 release | NW: X | NW: O | NW: O |
| | PP1-2 to CellG2 or CellG3 (optional) | UE: O | UE: O | UE: O |
| | PP1-2 to CellG1 release (if exists) | | | |
| P6-P7 | PP2 or PP3 among 2 CellGs (2/3) | NW: X | NW: O | NW: O |
| | PP1-2 to CellG2 or CellG3 (optional) | UE: O | UE: O | UE: O |
| P7-P8 | No PP2 or PP3 | NW: X | NW: O | NW: O |
| | PP1-2 to CellG2 release (optional) | UE: O | UE: O | UE: O |
| P8 | P1-1 CellG2 release (CellG 3) | NW: X | NW: O | NW: O |
| | PP1-2 to CellG2 release (if exists) | UE: O | UE: O | UE: O |

The CellG may mean an MCG. The CellG may include a PCell (e.g. serving cell) and SCell(s) in a CA relationship with the PCell within the same node (e.g. the same master node). From a coverage perspective, each of the three cell groups may include a unique region and overlapping region(s). The unique region may mean a region that does not overlap with coverage of other cells. The overlapping region may refer to a region that overlaps coverage of other cells. ‘CellG1/2’ may mean ‘CellG1 and CellG2’, and ‘CellG1/2/3’ may mean ‘CellG 1, CellG 2, and CellG 3’.

Solid circles in FIG. 3 may mean coverage of CellGs. Dotted lines in FIG. 3 may mean reference positions at which the PP1 procedure of FIG. 2 is triggered (e.g. prepared or released). Looking at the UE's movement path, the UE may move within a reference position of a preparation trigger of CellG2 after crossing a dotted line boundary P1 of CellG2. The UE may move into an overlapping coverage (e.g. overlapping region) between CellG1 and CellG2 after crossing a solid boundary P2 of CellG2. The UE may move into a reference position of a preparation trigger of CellG3 after crossing a dotted boundary P3 of CellG3. The UE may move into an overlapping coverage (e.g. overlapping region) between CellG1, CellG2, and CellG3 after crossing a solid boundary P4 of CellG3. The UE may move out of the coverage of CellG1 after crossing a solid boundary P5 of CellG1. The UE may move into a reference position of a release trigger of CellG1 after crossing a dotted boundary P6 of CellG1. The UE may move out of the coverage of CellG2 after crossing a solid boundary P7 of CellG2. The UE may move into a reference position of a release trigger of CellG2 after crossing a dotted boundary P8 of CellG2.
At P1, a mutual preparation procedure PP-1 for CellG1 and CellG2 (i.e., new CellG) may be performed. Optionally, a PP1-2 for procedure CellG2, which is an expected SpCell in CellG2, may be started.
In the P2-P3 section, a PP2 L1/L2 inter-cell switching procedure, a PP3 L1/L2 inter-cell switching procedure, or a handover procedure may be performed in CellG1 and/or CellG2. Optionally, the PP1-2 procedure for CellG2 may be performed.
At P3, a mutual preparation procedure PP1-1 for CellG1, CellG2, and CellG3 (i.e., new CellG) may be performed. Optionally, a PP1-2 procedure for CellG2 and CellG3 may be performed. If the serving cell belongs to CellG1, a PP1-2 procedure for CellG2 or CellG3 may be performed.
In the P3-P4 section, a PP2 L1/L2 inter-cell switching procedure, a PP3 L1/L2 inter-cell switching procedure, or a handover procedure may be performed in CellG1 and CellG2. Optionally, a PP1-2 procedure for CellG1 or CellG2 may be performed. If the serving cell belongs to CellG1, a PP1-2 procedure for CellG2 may be performed. If the serving cell belongs to CellG2, a PP1-2 procedure for CellG1 may be performed.
In the P4-P5 section, a PP2 L1/L2 inter-cell switching procedure, a PP3 L1/L2 inter-cell switching procedure, or a handover procedure may be performed in CellG1, CellG2, and CellG3. Optionally, a PP1-2 procedure for CellG2/3, CellG1/3, or CellG1/2 may be performed. If the serving cell belongs to CellG1, a PP1-2 procedure for CellG2 and CellG3 may be performed. If the serving cell belongs to CellG2, a PP1-2 procedure for CellG1 and CellG3 may be performed. If the serving cell belongs to CellG3, a PP1-2 procedure for CellG1 and CellG2 may be performed.
In the P5-P6 section, a PP2 L1/L2 inter-cell switching procedure, a PP3 L1/L2 inter-cell switching procedure, or a handover procedure may be performed in CellG2 and CellG3. Optionally, a PP1-2 procedure for CellG2 or CellG3 may be performed. If the serving cell belongs to CellG2, a PP1-2 procedure for CellG3 may be performed. If the serving cell belongs to CellG3, a PP1-2 procedure for CellG2 may be performed.
At P6, a mutual release procedure PP1-1 for CellG1 may be performed. Optionally, a PP1-2 procedure for CellG2 and CellG3 may be performed. If the serving cell belongs to CellG2, a PP1-2 procedure for CellG2 may be performed. If the serving cell belongs to CellG3, a PP1-2 procedure for CellG3 may be performed.
In the P7-P8 section, a PP2 procedure or PP3 procedure may not be performed. Optionally, a PP1-2 procedure for CellG2 may be performed. If the serving cell belongs to CellG3, a PP1-2 procedure for CellG2 may be performed
At P8, a mutual release procedure PP1-1 for CellG2 may be performed. If exists, a PP1-2 procedure for CellG2 may be released.

In Case A and Case B of FIG. 1, since related information (e.g. DU-related information) exists in the same CU, the mutual preparation procedure may refer to a configuration procedure of information for the L1/L2 inter-cell mobility procedure in the CU. The mutual release procedure may refer to a procedure of releasing information for the L1/L2 inter-cell mobility procedure. As in case C of FIG. 1, when CellG1, CellG2, and CellG3 exist in different CUs, Xn-C message(s) between the CUs may be used to configure and/or release the same information for the different CUs.

According to FIG. 3 and Table 1, when the preparation procedure and/or release procedure for PP1-1 according to the UE's movement path is performed, in case of two cells, an operation of exchanging Xn-C messages may be performed so that two CUs have the same information, and in case of three cells, an operation of exchanging Xn-C messages may be performed so that three CUs have the same information.

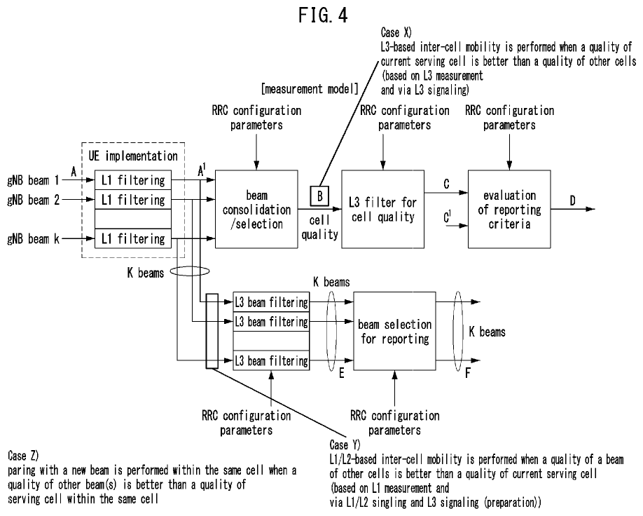

FIG. 4 is a conceptual diagram illustrating a quality measurement model.

Referring to FIG. 4, quality measurement for beam sweeping (e.g. beam sweeping using beam 1, beam 2, . . . , beam k) may be performed at a base station (e.g. gNB). In addition, quality measurement for beams of other base stations may be performed. L1 measurement and filtering for k beams may be operations performed by the UE. For L3 measurement-based inter-cell mobility, an integrated quality and quality selection for individual beam qualities may be configured by RRC parameters, and accordingly, a cell quality B of the base station may be obtained.

For individual beam quality, a quality E for an individual beam may be obtained through L3 beam filtering. The L3 beam filtering for individual beams and beam selection for reporting to the network may be configured by RRC parameters. If filtering coefficients in L3 beam filtering for an individual beam are 0, the L3 beam filtering may be interpreted as L1 filtering for A¹. A sampling rate for L1 measurements on beams may generally be fast, and results of the L1 measurements may be reported quickly. A sampling rate for L3 measurement may be slower than a sampling rate for L1 measurement, and a result of L3 measurement may be reported slowly than a result of L1 measurement. If filtering coefficients in L3 beam filtering is 0, the result of the L3 beam filtering may be A¹ shown in FIG. 4. In the L3 beam filtering, when the filtering coefficient increases as 1, 2, 3, or 4, the result of L3 beam filtering may be E shown in FIG. 4.

In FIG. 4, Case X, Case Y, and Case Z may be considered. In Case X, an L3-based inter-cell mobility procedure may be performed based on L3 measurement through L3 signaling. The L3-based inter-cell mobility procedure may be performed in a periodic or event-triggered manner based on the L3 measurement. For example, if the quality B of the current serving cell is lower than those of other cells, the L3-based inter-cell mobility procedure may be performed.

In Case Y, the existing L3 signaling may be added or the existing L3 signaling may be modified for L1/L2/L3 preparation, and an L1/L2 based inter-cell mobility procedure may be performed based on L1 measurement. If the quality of the current serving beam in the serving cell is lower than a quality of a beam in other cells, the L1/L2 based inter-cell mobility procedure may be performed.

In Case Z, while the terminal moves, the terminal may continue to perform operations for pairing with new beams within the same cell. If the serving beam quality is lower than the quality of other beams in the same serving cell, the beam may be changed.

The dotted and solid lines shown in FIG. 3 may be defined based on L3 measurement quality or L1 measurement quality. When L1 measurement quality is used, variability in radio quality may be relatively large. Therefore, the inter-cell mobility procedure may be performed adaptively. When L3 measurement quality is used, variability in radio quality may be relatively small. In this case, the inter-cell mobility procedure may be performed later. Depending on a specific situation, L1 measurement quality and/or L3 measurement quality may be used.

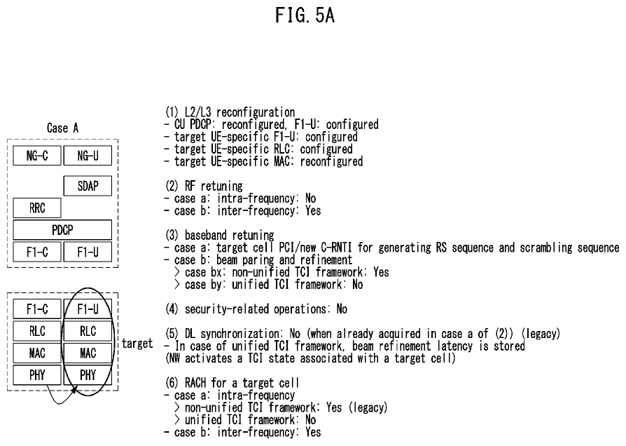

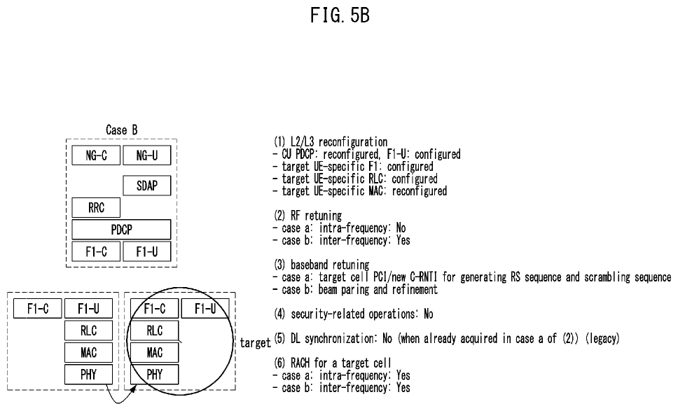

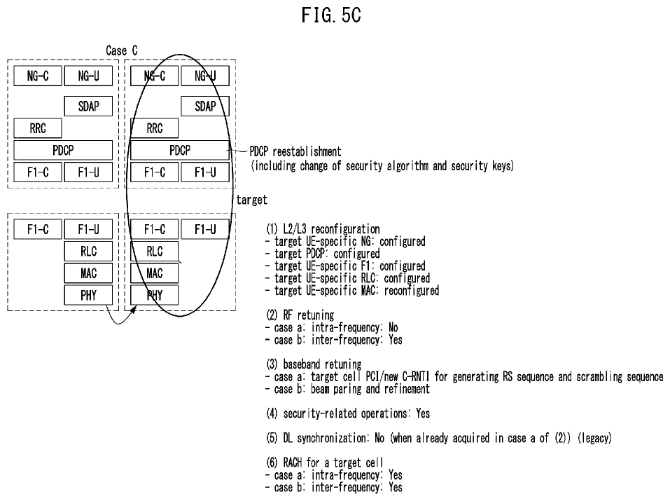

FIG. 5A is a conceptual diagram illustrating an exemplary embodiment of a reconfiguration range (or reuse range) in Case A of FIG. 1.

Referring to FIG. 5A, in Case A (e.g. intra-CU, intra-DU), a UE-specific part may be reconfigured in relation to MAC/radio link control (RLC)/F1-U of a target DU. In terms of L2/L3 reconfiguration, a CU packet data convergence protocol (PDCP) may be reconfigured, and a CU F1-U may be reconfigured. UE-specific information may be reconfigured in terms of PHY/MAC/RLC/F1-U of the target DU. If a source physical layer (PHY) and a target PHY correspond to intra-frequency, radio frequency (RF) tuning may not be required. If the source PHY and target PHY correspond to inter-frequency, RF tuning may be required.

In terms of baseband retuning, an operation of acquiring a target cell physical cell identifier (PCI) and a new cell-radio network temporary identifier (C-RNTI) for generating a reference signal (RS) sequence and a scrambling sequence, and a beam pairing and refinement operation may be performed. If a unified transmission configuration indication (TCI) framework is configured, the beam pairing and refinement operation may not be required. If the unified TCI framework is not configured, the beam pairing and refinement operation may be required.

Since the same PDCP is used, security-related operations may not be performed in Case A. In a case a of RF retuning, a DL synchronization operation may not be required. The unified TCI framework may be configured and a beam refinement latency may be stored. In this case, NW may activate a TCI state associated with a target cell. In a case b of RF retuning, a DL synchronization operation may be required. In case of an intra-frequency non-unified TCI framework in terms of a RACH for the target cell, a DL synchronization operation may be required. If an intra-frequency unified TCI framework is configured, a RACH procedure may not be required. In case of inter-frequency, a RACH procedure may be required.

FIG. 5B is a conceptual diagram illustrating an exemplary embodiment of a reconfiguration range (or reuse range) in Case B of FIG. 1.

Referring to FIG. 5B, in Case B (e.g. intra-CU, inter-DU), a UE-specific part may be reconfigured in relation to MAC/RLC/F1-C/F1-U of a target DU. In terms of L2/L3 reconfiguration, a CU PDCP may be reconfigured, and a CU F1-C and CU F1-U may be configured. UE-specific information may be reconfigured in terms of PHY/MAC/RLC/F1-C/F1-U of the target DU. If a source PHY and a target PHY correspond to intra-frequency, RF tuning may not be required. If the source PHY and the target PHY correspond to inter-frequency, RF tuning may be required.

In terms of baseband retuning, an operation of acquiring a target cell PCI and a new C-RNTI for generating an RS sequence and a scrambling sequence, and a beam pairing and refinement operation may be performed. Since the same PDCP is used, security-related operations may not be performed in Case B. In a case a of RF retuning, a DL synchronization operation may not be required. A RACH procedure for the target cell may be required at both intra-frequency and inter-frequency.

FIG. 5C is a conceptual diagram illustrating an exemplary embodiment of a reconfiguration range (or reuse range) in Case C of FIG. 1.

Referring to FIG. 5C, in case C (e.g. inter-CU, inter-DU), a UE-specific part may be reconfigured in relation to NG-C/NG-U/SDAP/RRC/PDCP/F1C-F1-U of a target CU and MAC/RLC/F1-C/F1-U of a target DU. In terms of L2/L3 reconfiguration, CU UE-specific NG-C/NG-U, SDAP, PDCP, and/or F1-C/F1-U may be configured. UE-specific information may be reconfigured in terms of PHY/MAC/RLC/F1-C/F1-U of the target DU. If a source PHY and a target PHY correspond to intra-frequency, RF tuning may not be required. If the source PHY and the target PHY correspond to inter-frequency, RF tuning may be required.

In terms of baseband retuning, an operation of acquiring a target cell PCI and a new C-RNTI for generating an RS sequence and a scrambling sequence, and a beam pairing and refinement operation may be performed. Since the same PDCP is used, security-related operations may not be performed in Case C. In a case a of RF retuning, a DL synchronization operation may not be required. A RACH procedure for the target cell may be required at both intra-frequency and inter-frequency.

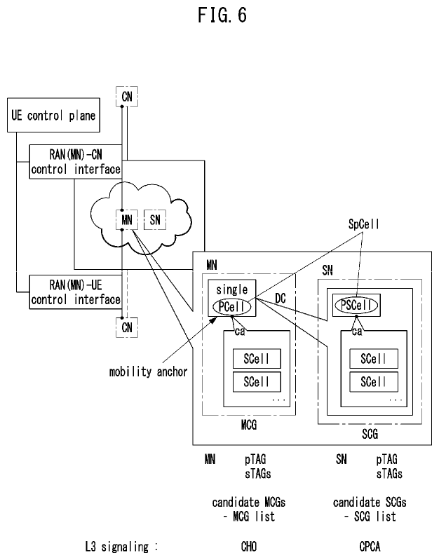

FIG. 6 is a conceptual diagram illustrating a control plane (CP) in a single PCell operation scheme.

Referring to FIG. 6, a control plane may have one radio access network (RAN)/master node (MN)-UE radio control interface and one RAN (MN)-core network (CN) wired control interface. In a single PCell operation scheme, the UE may perform an initial access procedure for an MN, a PCell may be determined by the initial access procedure, SCell(s) may be added in the same node (e.g. MN) as the PCell based on CA, and a PSCell may be added in a node (e.g. secondary node (SN)) different from that of the PCell based on DC. In addition, SCell(s) may be added in the same node as the PSCell based on CA. In other words, the SCell(s) added through CA based on the PCell, the PSCell added through DC based on the PCell, and the SCell(s) added through CA based on the PSCell may be associated with one PCell.

In a multi-connectivity situation, a quality of the MN's PCell may be an anchor of the entire mobility procedure, and a quality of the SN's PSCell may be a key to changing and/or adding the SN. Each of the PCell and the PSCell may be referred to as ‘SpCell’.

For DC, a master cell group (MCG) and a secondary cell group (SCG) may be defined. The MCG may include the PCell and SCell(s) of the MN to which the UE is connected. The SCG may include the PSCell and SCell(s) of the SN to which the UE is connected.

For a conditional handover (CHO), a candidate MCG list (e.g. target MCG list) for replacing the current MN may be configured. For a conditional PSCell change and addition (CPCA), a candidate SCG list (e.g. target SCG list) for replacing the current SN may be configured. To introduce a concept of different uplink timings for CA, a primary timing advance group (pTAG) for the SpCells and a secondary TAG (sTAG) for the SCells may be defined.

A baseband handover, CHO, and/or dual active protocol stack (DAPS) HO by L3-based signaling may be defined. In the CHO, NW may generate a candidate MCG list, NW may transmit the candidate MCG list to the UE, the UE may select one candidate MCG list among the candidate MCG lists, and the UE may perform an connection procedure for the one candidate MCG list. In the DAPS HO, a dual stack may be maintained at a boundary of two cells for continuity of data transmission in a user plane (UP), and thus a possibility of data interruption may be reduced. In the CPCA, a change and/or addition of a PSCell for candidate cells may be defined. The current technical specifications do not support simultaneous execution of DAPS HO and CHO, simultaneous execution of DAPS HO and CPCA, and/or simultaneous execution of CHO and CPCA.

The L1/L2 MCG list may be utilized in the PP1 procedure, similarly to the use of the MCG list in FIG. 6. The UE may access two SpCells simultaneously as in the MR-DC in FIG. 6. The operation of the UE may be performed selectively. The above operation may be utilized in the L1/L2 based inter-cell mobility procedure.

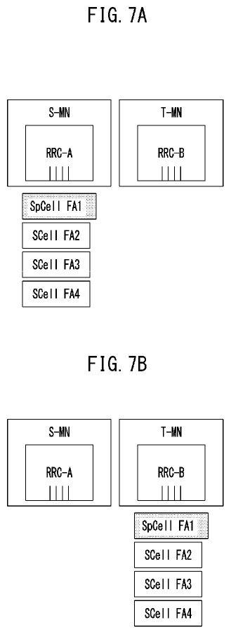

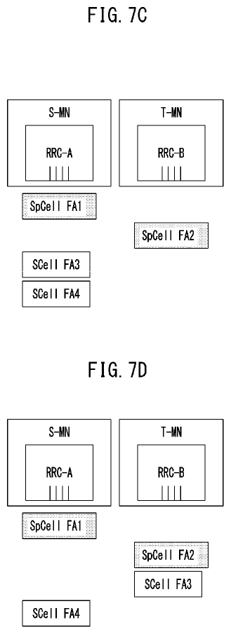

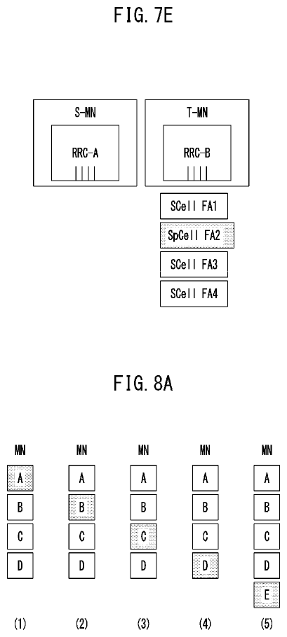

FIGS. 7A to 7E are conceptual diagrams illustrating possible states in each of source (S)-MN and target (T)-MN.

Referring to FIG. 7A, the UE may be connected to an S-MN. An SpCell FA1, which uses an FA1 frequency in the S-MN, may be configured as a primary component carrier (CC). In the S-MN, an SCell FA2, an SCell FA3, and an SCell FA4 may be used in the CA scheme. A cell (e.g. carrier) may not move to a T-MN.

Referring to FIG. 7B, the UE may not be connected to the S-MN, and the UE may be connected to the T-MN. An SpCell FA1, which uses the FA1 frequency in the T-MN, may be configured as a primary CC. In the T-MN, an SCell FA2, an SCell FA3, and an SCell FA4 may be used in the CA scheme. The L3 inter-cell mobility procedure from the state of FIG. 7A to the state of FIG. 7B may be performed, and detailed procedures for the L3 inter-cell mobility procedure may exist. A preparation step for one SpCell or a preparation step for three SpCells may be performed. Activation/deactivation of the SCells in the T-MN may be indicated by a MAC CE (e.g. MAC message). Addition or release of the SCell(s) may be performed by L3 signaling.

Referring to FIGS. 7C to 7E, the CC(s) of the S-MN may move to the T-MN. For example, the configuration state of the CC(s) of the T-MN may be changed as ‘state of FIG. 7A→state of FIG. 7C→state of FIG. 7D→state of FIG. 7E’. For MR-DC, two SpCells (e.g. PCell, PSCell) may be configured in the MN and SN. In the inter-cell mobility procedure, two SpCells may be configured in the S-MN and T-MN. In this case, in the state of FIG. 7A, the SCell FA2 in the S-MN may be deactivated (or released), the SpCell FA2 in the T-MN may be configured (e.g. activated), the SCell FA3 and SCell FA4 may be sequentially move from the S-MN to the T-MN, and finally, the SpCell FA1 in the S-MN may be deactivated, and the SCell FA1 in the T-MN may be activated.

NW may prepare an L1/L2 MCG based on L3 signaling and inform the UE of the L1/L2 MCG. According to L1/L2 signaling based on L1 measurement, the CC(s) in the S-MN may be quickly activated or deactivated. In addition, the CC(s) in the T-MN may be quickly activated or deactivated. In this case, the inter-cell mobility procedure may be performed quickly.

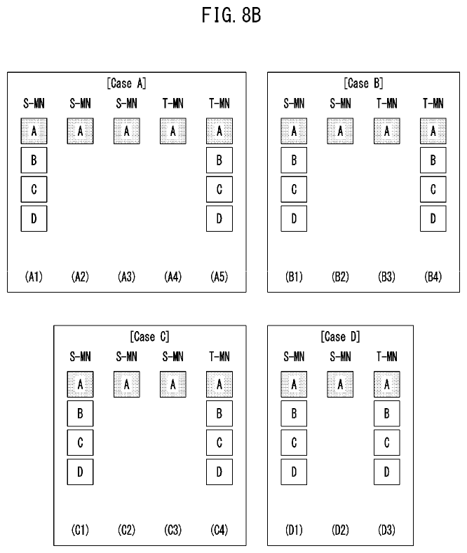

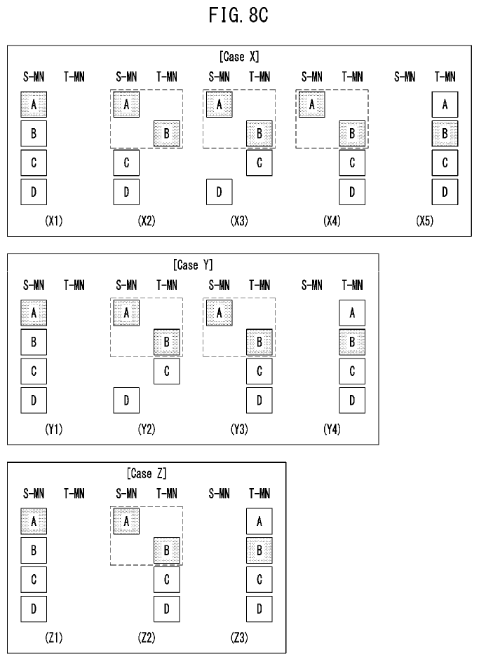

FIG. 8A is a conceptual diagram illustrating a vertical mobility procedure under a CA situation.

Referring to FIG. 8A, the MN may support CA. In the MN, a CC A may be configured as a PCell, and the remaining CCs (e.g. CCs B, C, and D) may be configured as SCells. In the same MN, the PCell may be changed from the CC A to the CC B, the PCell may be changed from the CC B to the CC C, the PCell may be changed from the CC C to the CC D, and the PCell may be changed from the CC D to the CC E. The mobility procedure for CCs may be defined as a vertical mobility procedure.

FIG. 8B is a conceptual diagram illustrating a horizontal mobility procedure under a CA situation.

Referring to FIG. 8B, in Case A, a horizontal mobility procedure may be performed in the order of ‘A1→A2→A3→A4→A5’. In Case B, a horizontal mobility procedure may be performed in the order ‘B1→B2→B3→B4’. In Case C, a horizontal mobility procedure may be performed in the order ‘C1→C2→C3→C4’. In Case D, a horizontal mobility procedure may be performed in the order ‘D1→D2→D3’.

In Case A, the secondary CCs (SCCs) B/C/D of the S-MN may be removed by L2 signaling in (A2), the S-MN may transmit a HO command for the T-MN to the UE in (A3), the T-MN may receive a HO complete in (A4), and the T-MN may activate the SCCs B/C/D using L2 signaling in (A5).

In Case B, the S-MN may transmit a HO command to the UE using L3 signaling in (B2), the HO command includes information indicating to move the primary CC (PCC) A to the T-MN and information indicating to remove the SCCs B/C/D of the S-MN, the T-MN may receive the HO complete in (B3), and the T-MN may activate the SCCs B/C/D by using L2 signaling in (B4).

In Case C, the SCCs B/C/D of the S-MN may be removed by L2 signaling in (C2), the S-MN may transmit a HO command to the UE using L3 signaling in (C3), and the HO command may include information indicating to change the PCC to the PCC A of the T-MN and information indicating to add the SCCs B/C/D to the T-MN. The T-MN may receive a HO complete, and the T-MN may activate the SCCs B/C/D using L2 signaling in (C4).

In case D, the S-MN may transmit a HO command to the UE using L3 signaling in (D2), the HO command may include information indicating to change the PCC to the PCC A of the T-MN, information indicating to remove the SCCs B/C/D of the S-MN, and information indicating to add the SCCs B/C/D to the T-MN. The T-MN may receive the HO complete and the T-MN may activate the SCCs B/C/D using L2 signaling in (D3).

Under the CA situation, the L3 signaling used in four cases (e.g. Cases A, B, C, and D) may be replaced with L2 signaling. For the PP-1 procedure, L3 signaling may be used, and after all preparations are completed, the L2 signaling based inter-cell mobility procedure may be performed based on minimal information.

FIG. 8C is a conceptual diagram illustrating a dual SpCell horizontal mobility procedure under a CA situation.

Referring to FIG. 8C, in Case X, a dual SpCell horizontal mobility procedure may be performed in the order of ‘X1→X2→X3→X4→X5’. In Case Y, a dual SpCell horizontal mobility procedure may be performed in the order of ‘Y1→Y2→Y3→Y4’. In Case Z, a dual SpCell horizontal mobility procedure may be performed in the order ‘Z1→Z2→Z3’.

In (X1) of Case X, the CC A may be configured as a PCC in the S-MN, and the CCs B, C, and D may be configured as SCCs in the S-MN. In (X2) of Case X, the CC B in the S-MN may be deactivated, and the CC B may be configure as an SpCell in the T-MN. In (X3) of Case X, the CC C may be deactivated in the S-MN, and the CC C may be configured as an SCell in the T-MN. In (X4) of Case X, the CC D may be deactivated in the S-MN, and the CC D may be configured as an SCell in the T-MN. In (X5) of Case X, the CC A (e.g. PCell) may be removed in the S-MN, and the CC A may be configured as an SCell in the T-MN.

In (Y1) of Case Y, the CC A may be configured as a PCC in the S-MN, and the CCs B, C, and D may be configured as SCCs in the S-MN. In (Y2) of Case Y, the CCs B and C may be deactivated in the S-MN, the CC B may be configured as an SpCell in the T-MN, and the CC C may be configured as an SCell in the T-MN. In (Y3) of Case Y, the CC D may be deactivated in the S-MN, and the CC D may be configured as an SCell in the T-MN. In (Y4) of Case Y, the CC A (e.g. PCell) may be removed in the S-MN, and the CC A may be configured as an SCell in the T-MN.

In (Z1) of Case Z, the CC A may be configured as a PCC in the S-MN, and the CCs B, C, and D may be configured as SCCs in the S-MN. In (Z2) in Case Z, the CCs B, C, and D may be deactivated in the S-MN, the CC B may be configured as an SpCell in the T-MN, and the CCs C and D may be configured as SCells in the T-MN. In (Z3) of Case Z, the CC A (e.g. PCell) may be removed in the S-MN, and the CC A may be configured as an SCell in the T-MN.

The L2 signaling based inter-cell mobility procedure may be performed by replacing the L3 signaling in the exemplary embodiment of FIG. 8B with L2 signaling. In the exemplary embodiment of FIG. 8C, the L2 signaling based inter-cell mobility procedure may be performed based on the scheme in which the SpCell is operated in each of the two nodes.

PP1: Proactive multi-L1/L2 MCG set preparation
PP1-1: Multiple L1/L2 MCGs (or SCGs) using L3 signaling
PP1-2: Target TA estimate, periodic RA procedure, TA storage

PP2: Horizontal multi-graps dynamic switching
SpCell vertical/horizontal updates through measurement/reporting/acknowledgement (ACK) using L1/L2 signaling
Case A and Case B shown in FIG. 1

PP3: Horizontal multi-graps dynamic handover
SpCell vertical/horizontal updates through L3 measurement/reporting using L3 signaling or L1/L2 signaling
Case C shown in FIG. 1

PP1: Proactive multi-L1/L2 MCG set preparation

PP1-1: Multiple L1/L2 MCGs (or SCGs) using L3 signaling

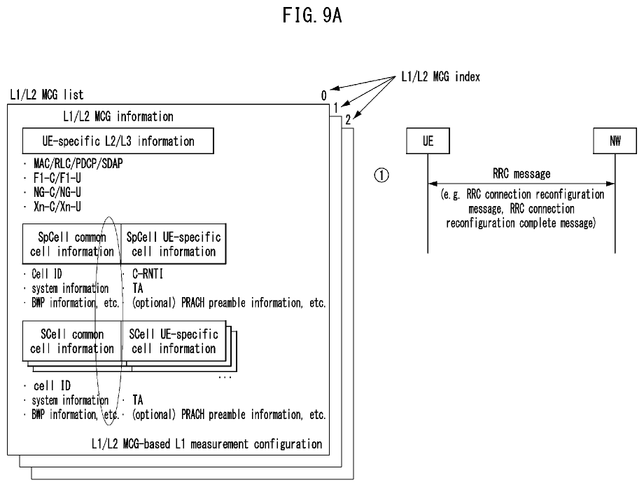

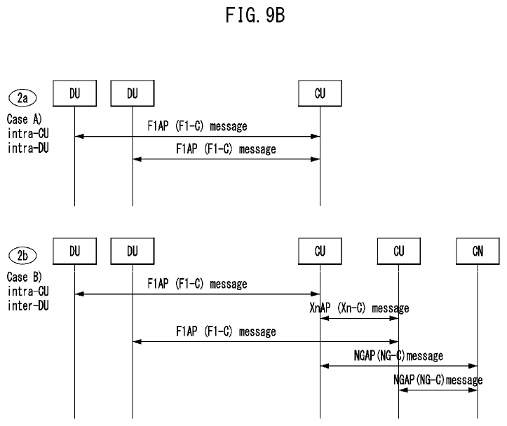

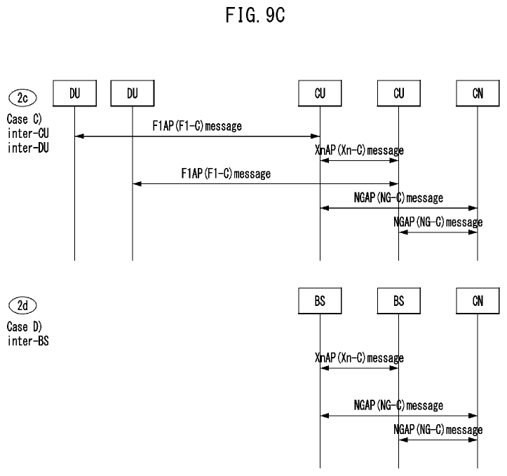

For the preparation step (e.g. PP1) of proactive multi-L1/L2 MCG set for the L1/L2-based inter-cell mobility procedure, the existing L3 signaling message may be utilized. If a message for the purpose of the preparation step does not exist, a new message may be used. The message (e.g. L3 signaling message, new message) may include information element(s) shown in FIGS. 9A to 9C. The information element(s) may be shared by NW and/or UE. By sharing the above information element(s), PP2 and/or PP3 may be supported seamlessly.

FIGS. 9A to 9C are conceptual diagrams illustrating a method of sharing information among entities belonging to NW.

Referring to FIGS. 9A to 9C, ‘2a’ may represent messages used by entities belonging to NW to share information with each other in Case A (e.g. intra-CU, intra-DU) of FIG. 1. ‘2b’ may represent messages used by entities belonging to NW to share information with each other in Case B (e.g. intra-CU, inter-DU) of FIG. 1. ‘2c’ may represent messages used by entities belonging to NW to share information with each other in case C of FIG. 1 (e.g. inter-CU, inter-DU).

In Case A of FIG. 1, a pre-preparation procedure may be performed using F1AP L3 signaling as shown in ‘2a’ of FIG. 9B. In Case B of FIG. 1, a pre-preparation procedure may be performed using F1AP L3 signaling as shown in ‘2b’ of FIG. 9B. In Case C of FIG. 1, a pre-preparation procedure may be performed using F1AP/XnAP/NGAP L3 signaling as shown in ‘2c’ of FIG. 9C.

When the pre-preparation procedure is performed in NW and information on the pre-preparation procedure is transmitted to the UE, the information on the pre-preparation procedure may be transmitted using an RRC message (e.g. RRC connection reconfiguration, RRC connection reconfiguration complete) as shown in ‘1’ in FIG. 9A. When the information on the pre-preparation step is transmitted to the UE, L1/L2 MCG information (e.g. L1/L2 MCG information elements) in FIG. 9A may be included in the existing information elements defined by RRC for the respective information categories and information elements. If there is no existing information elements defined by RRC for the respective information categories and information elements, the L1/L2 MCG information may be included in other information elements defined by RRC. Alternatively, new L1/L2 MCG information element(s) may be defined, an L1/L2 MCG list including N L1/L2 MCG information element(s) may be generated, and the L1/L2 MCG list may be transmitted to the UE. N may be a natural number.

‘2d’ in FIG. 9C may represent a pre-preparation procedure in an S-MN/T-MN structure rather than a CU/DU shown in ‘2c’ in FIG. 9C. In ‘2d’ of FIG. 9C, the F1AP message may not be used, and the XnAP/NGAP messages may be used. ‘2d’ in FIG. 9C may be a subset of ‘2c’ in FIG. 9C, and ‘2c’ excluding the F1AP message may be ‘2d’. Exemplary embodiments of the present disclosure may be described focusing on ‘2d’.

An L1/L2 MCG list may be generated, and indices (e.g. 0, 1, 2) may be numbered for the respective L1/L2 MCG information elements included in the L1/L2 MCG list. UE-specific L2/L3 information may include MAC/RLC/PDCP/SDAP information, F1-C/F1-U information, NG-C/NG-U information, and/or Xn-C/Xn-U information. Depending on each case, some information may or may not be needed in the preparation procedure. UE-specific L2/L3 information may be transmitted to the UE. Therefore, separate network interface information (e.g. F1-C/F1-U information, NG-C/NG-U information, and/or Xn-C/Xn-U information) may not be transmitted to the UE.

Among CCs, CCs that can be configured as an SpCell may be classified into SpCell common cells and SpCell UE-specific cells. Information of the SpCell common cells and information of the SpCell UE-specific cells may be managed. In other words, the information of the SpCell common cells and the information of the SpCell UE-specific cells may be prepared in advance. Among CCs that can be managed through CA at the same location, CCs that can be configured as an SpCell may be classified into SpCell common cells and SpCell UE-specific cells. Information of the SpCell common cells and information of the SpCell UE-specific cells may be managed. In other words, the information of the SpCell common cells and the information of the SpCell UE-specific cells may be prepared in advance.

The L1/L2 MCG information elements may include L1 measurement configuration information. The L1 measurement configuration information may be L1 measurement configuration information for the SpCell and SCell(s) and/or the SpCell and SCell(s) of other MCG. The L1 measurement configuration information may be managed, and L1/L2 MCG information elements may be transmitted to the UE. The L1 measurement configuration information may be L1 measurement configuration information based on the L1/L2 MCG (e.g. L1/L2 MCG index). Therefore, individual L1 measurement configuration information may exist for each L1/L2 MCG index.

SpCell UE-specific cell information may include a unique ID (e.g. C-RNTI) and/or a TA. The unique ID may be a C-RNTI that the UE can use in the cell. The SpCell UE-specific cell information may optionally include information of a physical random access channel (PRACH) preamble. The TA acquired by PP1-2 may be updated, and the updated TA may be stored. Thereafter, when a contention free random access (CFRA) procedure is performed, information on a PRACH preamble used by the UE in the CFRA procedure may be included in the SpCell UE-specific cell information.

SpCell common cell information may include a cell ID, system information, and/or BWP information. The SpCell common cell information may be transmitted to the UE. For example, in a state where an SpCell for L1/L2 MCG index 0 is a serving PCell, if NW transmits information on an L1/L2 MCG index 1 to the UE through the L1/L2 MCG index 0, and a pre-preparation procedure is performed by transmitting information on the L1/L2 MCG index 1, a time require for the UE to perform camping may be saved in the inter-cell mobility procedure based on the L1/L2 MCG index 1.

In ‘1’ of FIG. 9A, NW may prepare L1/L2 MCG information and transmit the L1/L2 MCG information to the UE using an RRC protocol (e.g. RRC message). For example, the L1/L2 MCG information may be included in an RRC connection reconfiguration message, an RRC connection reconfiguration complete message, or a new RRC message. Network interface information (e.g. information on F1, Xn, and/or NG) may not be transmitted to the UE.

‘2a’ in FIG. 9B may represent network interface(s) used for generation/transmission of L1/L2 MCG information in Case A. ‘2b’ in FIG. 9B may represent network interface(s) used for generation/transmission of L1/L2 MCG information in Case B. ‘2c’ of FIG. 9C may represent network interface(s) used for generation/transmission of L1/L2 MCG information in Case C. The existing network interfaces (e.g. F1, Xn, NG) may be utilized for PP1-1. Alternatively, the existing message(s) may be modified, existing message(s) may be expanded, or new message(s) may be utilized.

In ‘2d’ of FIG. 9C, the existing message(s) or new message(s) for the interfaces (e.g. Xn, NG) for PP1-1 in a structure (e.g. a structure of two independent base stations) other than the DU/CU structure may be defined. ‘2d’ may be interpreted as ‘2c’ without use of the F1 interface.

As in the exemplary embodiment of FIG. 3, the UE may initially only have information on CellG1 corresponding to its serving L1/L2 MCG (e.g. serving L1/L2 MCG index 0). In P1 of FIG. 3, NW may have an L1/L2 MCG associated with CellG1 (e.g. L1/L2 MCG index 0) and an L1/L2 MCG associated with CellG2 (e.g. L1/L2 MCG index 1), and information on a new L1/L2 MCG (e.g. L1/L2 MCG index 1) may be transmitted to the UE. In P3 of FIG. 3, NW may have an L1/L2 MCG (e.g. L1/L2 MCG index 0) associated with CellG1, an L1/L2 MCG (e.g. L1/L2 MCG index 1) associated with CellG2, and an L1/L2 MCG (e.g. L1/L2 MCG index 2) associated with CellG3, and information on the new L1/L2 MCG (e.g. L1/L2 MCG index 2) may be transmitted to the UE.

In P6 of FIG. 3, NW may remove the L1/L2 MCG (e.g. L1/L2 MCG index 0) associated with CellG1, and NW may have an L1/L2 MCG (e.g. L1/L2 MCG index 1) associated with CellG2 and an L1/L2 MCG (e.g. L1/L2 MCG index 2) associated with CellG3, and deletion of information on the L1/L2 MCG (e.g. L1/L2 MCG index 0) may be requested from the UE. In P8 of FIG. 3, NW may delete the L1/L2 MCG (e.g. L1/L2 MCG index 1) associated with CellG2, and the NW may delete the L1/L2 MCG (e.g. L1/L2 MCG index 1) associated with CellG3, and deletion of the L1/L2 MCG (e.g. L1/L2 MCG index 1) may be requested from the UE.

PP1-2: Target TA estimate, periodic RA, or TA storage

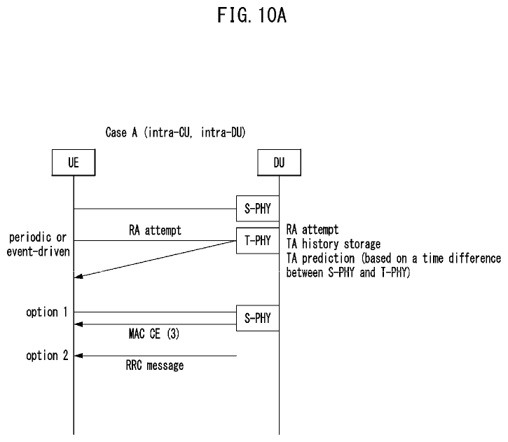

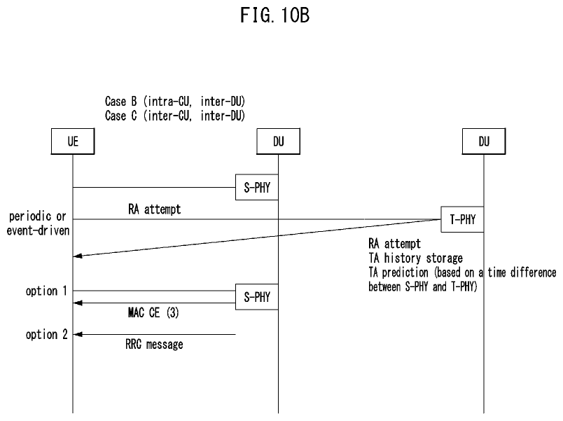

FIG. 10A is a sequence chart illustrating a first exemplary embodiment of a method for acquiring a TA, and FIG. 10B is a sequence chart illustrating a second exemplary embodiment of a method for acquiring a TA.

Referring to FIGS. 10A and 10B, NW (e.g. DU) or UE may acquire a TA in advance. In Case A, the UE may be connected to a serving (S)-PHY of a DU and may periodically perform an RA procedure for a target (T)-PHY of the DU or an RA procedure for the T-PHY according to an event. The UE may have an index of an L1/L2 MCG including the T-PHY. If a PRACH preamble (e.g. RACH preamble) for the T-PHY exists, the UE may perform CFRA. If the PRACH preamble for T-PHY does not exist, the UE may perform contention-based random access (CBRA). The UE may acquire a TA for the T-PHY through the RA procedure. Alternatively, the UE may transmit an RA preamble (e.g. PRACH preamble, RACH preamble) in the RA procedure and receive a MAC CE 3 including information on the TA for the T-PHY from the S-PHY. The information on the TA for the T-PHY may be obtained from the T-PHY.

In the L1/L2 MCG information, the TA for the L1/L2 MCG index may be updated, and the S-PHY may transmit an RRC message including information on the updated TA to the UE. The current T-PHY may be the previous S-PHY. NW may store TA history and provide the stored TA history to the UE. If a time difference between the S-PHY and T-PHY is identified, the S-PHY may estimate the TA for the T-PHY based on the current TA of the S-PHY and provide information on the estimated TA to the UE.

In Case B and/or Case C, the information on the TA for the T-PHY may be transmitted to the UE via a MAC CE 3 and/or RRC message. In this case, information transfer through the existing network interface may be necessary. For example, in Case B, an FIAP message (e.g. F1AP protocol message) may be used. In case C, an XnAP message (e.g. XnAP protocol message) and/or F1AP messages (e.g. F1AP protocol message) may be used.

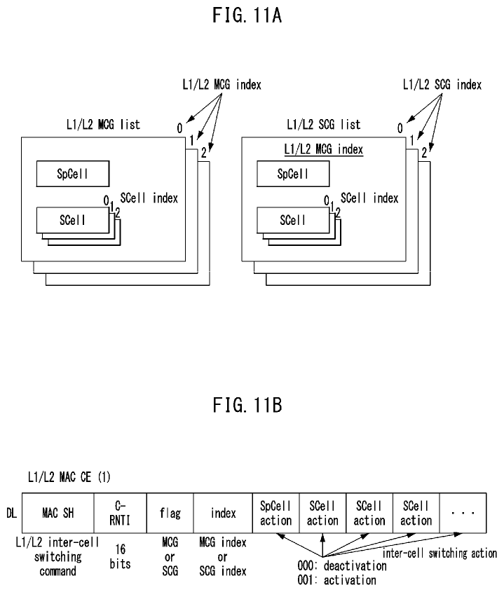

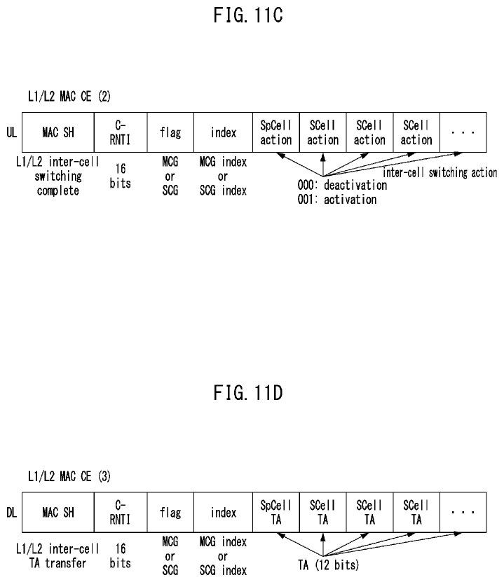

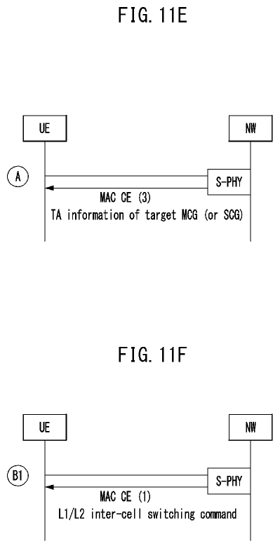

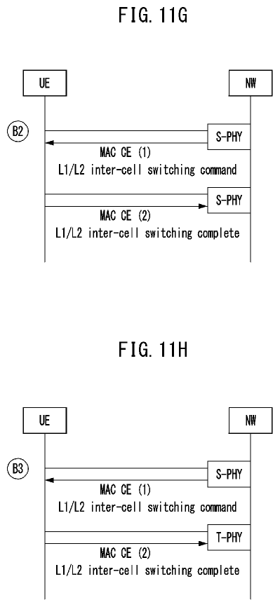

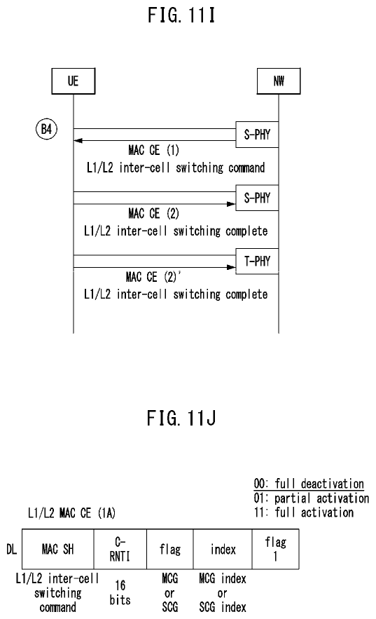

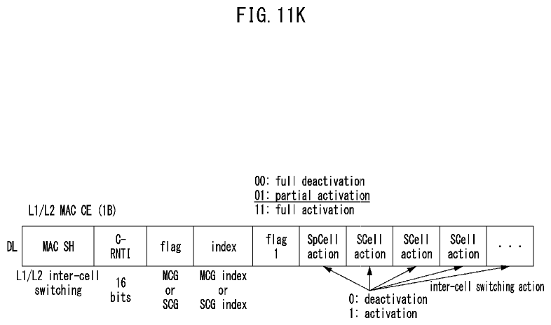

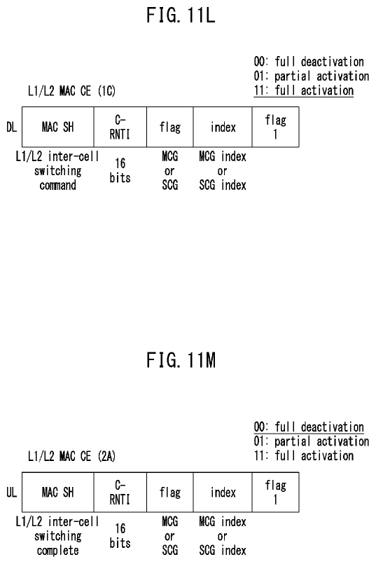

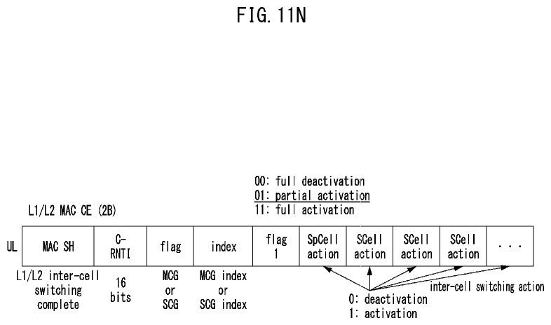

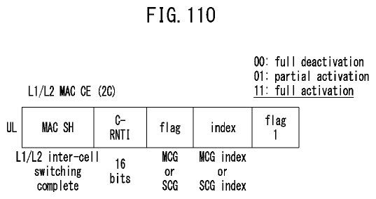

FIGS. 11A to 11I are conceptual diagrams illustrating exemplary embodiments of a structure and transmission of a MAC CE.

Referring to FIGS. 11A to 11I, a MAC CE (e.g. MAC message) may be used in PP2 and/or PP3. The L1/L2 MCG information (e.g. L1/L2 MCG list) in FIG. 11A may be a simplified version of the L1/L2 MCG information (e.g. L1/L2 MCG list) in FIG. 9. NW may manage the L1/L2 MCG information (e.g. L1/L2 MCG list) and/or L1/L2 SCG information (e.g. L1/L2 SCG list). Under a DC situation, the L1/L2 MCG list and the L1/L2 SCG list associated with the L1/L2 MCG list may exist in NW.

An index of the first L1/L2 MCG information included in the L1/L2 MCG list may be 0, an index of the second L1/L2 MCG information included in the L1/L2 MCG list may be 1, and an index of the third L1/L2 MCG information included in the L1/L2 MCG list may be 2. An index of the first L1/L2 SCG information included in the L1/L2 SCG list may be 0, an index of the second L1/L2 SCG information included in the L1/L2 SCG list may be 1, and an index of the third L1/L2 SCG information included in the L1/L2 SCG list may be 2.

The L1/L2 MAC CE 1 may be a downlink MAC CE. One bit among reserved bits of a MAC sub-header (SH) may be used to indicate an L1/L2 inter-cell switching command. The first field of a MAC service data unit (SDU) may be set to the C-RNTI indicating the UE. The size of C-RNTI may be 16 bits. The second field of the MAC SDU may be a flag field, and the flag field set to a first value (e.g. 0) may indicate the MCG, and the flag field set to a second value (e.g. 1) may indicate the SCG. The third field of the MAC SDU may be an index field. The index field may indicate the index of the MCG (e.g. L1/L2 MCG) or SCG (e.g. L1/L2 SCG).

An SpCell action field and SCell action field(s) may exist after the third field of the MAC SDU. The SpCell action field and SCell action field(s) may be action fields for inter-cell switching. The SpCell action field and SCell action field(s) may be collectively referred to as action fields. The arrangement order of the SCell action fields in the MAC SDU may be the index order of the SCell list included in the L1/L2 MCG (or L1/L2 SCG). The inter-cell switching action may indicate an operation for a CC in the T-MCG (or T-SCG). The action field set to a first value (e.g. 000) may indicate deactivation of a CC associated with the action field. The action field set to a second value (e.g. 001) may indicate activation of a CC associated with the action field.

The UE may receive the MAC CE 2 (e.g. L1/L2 MAC CE 2). If a flag field and an index field included in the MAC CE 2 indicate the T-MCG (or T-SCG) rather than the UE's S-MCG (or S-SCG) (e.g. if the flag field and the index field indicate a candidate MCG/SCG list rather than a serving MCG/SCG list), deactivation may mean deactivation of a CC for the T-MCG (or T-SCG), and activation may mean deactivation of a CC for the T-MCG (or T-SCG). When an SpCell is activated in the T-MCG and an SpCell is deactivated in the S-MCG, the inter-cell mobility procedure may be performed. When an SpCell is activated in the T-MCG and an SpCell is activated in the S-MCG, it may be determined that two SpCells exist at the same time, and the SpCell may be activated by a MAC CE 2 of the PCell.

If the flag field and index field included in the MAC CE 2 indicate the UE's S-MCG (or S-SCG) (e.g. if the flag field and the index field indicate a serving MCG/SCG list), deactivation may mean deactivation of a CC for the S-MCG (or S-SCG), and activation may mean activation of a CC for the S-MCG (or S-SCG). Since the MAC CE used to indicate activation or deactivation of SCells in the serving S-MCG/S-SCG already exists, the existing MAC CE may be used in this case.

The L1/L2 MAC CE 2 may be an uplink MAC CE. The L1/L2 MAC CE 2 may be a response to the L1/L2 MAC CE 1. The L1/L2 MAC CE 2 may be transmitted to the S-MCG (or S-SCG) that transmitted the L1/L2 MAC CE 1. Alternatively, the L1/L2 MAC CE 2 may be transmitted to the T-MCG (or T-SCG) rather than the current S-MCG (or S-SCG), which is indicated by the L1/L2 MAC CE 2.

The L1/L2 MAC CE 3 may be a downlink MAC CE. NW may update the TA based on the L1/L2 MCG information and/or the L1/L2 SCG information. Alternatively, the NW may acquire a new TA based on the L1/L2 MCG information and/or L1/L2 SCG information. The NW may transmit the L1/L2 MAC CE 3 including the updated TA (or new TA) to the UE. The first field of a MAC SDU may be set to the C-RNTI indicating the UE. The size of C-RNTI may be 16 bits. The second field of the MAC SDU may be a flag field, the flag field set to a first value (e.g. 0) may indicate the MCG, and the flag field set to a second value (e.g. 1) may indicate the SCG. The third field of the MAC SDU may be an index field. The index field may indicate the index of the MCG (e.g. L1/L2 MCG) or SCG (e.g. L1/L2 SCG). An SpCell TA field and SCell TA field(s) may exist after the third field of the MAC SDU.

In FIG. 11E (e.g. ‘A’ of FIG. 11E), the S-PHY may transmit the MAC CE 3 to the UE. The MAC CE 3 may include information on the TA for the T-MCG (or T-SCG). NW may identify whether the MAC CE 3 is successfully received by the UE based on a hybrid automatic repeat request (HARQ)-ACK for the MAC CE 3.

In FIG. 11F (e.g. ‘B1’ of FIG. 11F), the S-PHY may transmit the MAC CE 1 to the UE. The MAC CE 1 may include information indicating activation or deactivation of a CC for the S-MCG (or S-SCG). Alternatively, the MAC CE 1 may include information indicating activation or deactivation of a CC for the T-MCG (or T-SCG). NW may identify whether the MAC CE 1 is successfully received by the UE based on a HARQ-ACK for the MAC CE 1.

In FIG. 11G (e.g. ‘B2’ of FIG. 11G), the S-PHY may transmit the MAC CE 1 to the UE. The MAC CE 1 may include information indicating activation or deactivation of a CC for the S-MCG (or S-SCG). Alternatively, the MAC CE 1 may include information indicating activation or deactivation of a CC for the T-MCG (or T-SCG). The UE may transmit the MAC CE 2 to the S-PHY. NW may identify whether the MAC CE 1 is successfully received by the UE based on the MAC CE 2.

In FIG. 11H (e.g. ‘B3’), the S-PHY may transmit the MAC CE 1 to the UE. The MAC CE 1 may include information indicating activation or deactivation of a CC for the T-MCG (or T-SCG). NW may identify whether the MAC CE 1 is successfully received by the UE based on HARQ-ACK for the MAC CE 1. The UE may transmit a MAC CE 2 including the same MAC SDU as the MAC SDU of the MAC CE 1 to the T-PHY. The uplink transmission of the MAC CE 2 may be interpreted as a HARQ-ACK for the message (e.g. MAC CE 1) associated with the MAC CE 2.

In FIG. 11I (e.g. ‘B4’), the S-PHY may transmit the MAC CE 1 to the UE. The MAC CE 1 may include information indicating activation or deactivation of a CC for the T-MCG (or T-SCG). The UE may transmit the MAC CE 2 to the S-PHY. NW may identify whether the MAC CE 1 is successfully received from the UE based on the MAC CE 2. In addition, the UE may transmit the MAC CE 2 to the T-PHY. The uplink transmission of the MAC CE 2 may be interpreted as a HARQ-ACK for the message (e.g. MAC CE 1) associated with the MAC CE 2.

The MAC CE may be transmitted in various manners. Exemplary embodiments of the present disclosure may be described focusing on FIG. 11H (e.g. ‘B3’). In FIG. 11H, only the MAC CE 1 may be transmitted, and transmission of the MAC CE 2 may be omitted. In other words, since the HARQ-ACK for the MAC CE 1 may be recognized as transmission of uplink data for the T-PHY, transmission of the MAC CE 2 may be omitted.

FIGS. 11J to 11L are conceptual diagrams illustrating other exemplary embodiments of the L1/L2 MAC CE 1, and FIGS. 11M to 11O are conceptual diagrams illustrating other exemplary embodiments of the L1/L2 MAC CE 2.

The L1/L2 MCG list and/or L1/L2 SCG list shown in FIG. 11A may be applied to the exemplary embodiments of FIGS. 11J to 11O. The exemplary embodiments of FIGS. 11E to 11I may be applied to the exemplary embodiments of FIGS. 11J to 11O.

Referring to FIG. 11J, an L1/L2 MAC CE 1A may be a DL MAC CE. The DL MAC CE may be a MAC CE transmitted by a base station (e.g. DU) to the UE. One bit among reserved bits included in a MAC SH of the L1/L2 MAC CE 1A may be used to indicate an inter-cell switching command (e.g. inter-cell mobility command). In the L1/L2 MAC CE 1A, a C-RNTI field, flag field, index field, and flag1 field may be located after the MAC SH. The C-RNTI field may indicate a C-RNTI in the current serving MCG. The flag field may indicate that an index indicated by the index field is an MCG index or SCG index. For example, the flag field set to a first value (e.g. 0) may indicate an MCG, and the flag field set to a second value (e.g. 1) may indicate an SCG. The index field may indicate an index of the MCG (e.g. L1/L2 MCG) or SCG (e.g. L1/L2 SCG). The size of the flag1 field may be 2 bits. The flag1 field set to 00 may indicate deactivation of an SpCell and SCell(s) (e.g. SCell(s) belonging to an SCell list) in the MCG (or SCG) corresponding to the MCG index (or SCG index).

When the flag field indicates he MCG, the MCG index indicated by the index field is the same as the index of the currently serving MCG, and the flag1 field is set to 00, the UE may deactivate all SpCells and all SCells in the current MCG. When the flag field indicates the MCG, the MCG index indicated by the index field is different from the index of the currently serving MCG, and the flag1 field is set to 00, the UE may identify that all SpCells and all SCells within the MCG having the MCG index indicated by the index field are to be deactivated.

Referring to FIG. 11K, an L1/L2 MAC CE 1B may be a DL MAC CE. One bit among reserved bits included in a MAC SH of the L1/L2 MAC CE 1B may be used to indicate an inter-cell switching command. In the L1/L2 MAC CE 1B, a C-RNTI field, flag field, index field, flag1 field, SpCell action field, and SCell action field(s) may be located after the MAC SH. The C-RNTI field may indicate a C-RNTI in the current serving MCG. The flag field may indicate that an index indicated by the index field is an MCG index or SCG index. For example, the flag field set to a first value (e.g. 0) may indicate an MCG, and the flag field set to a second value (e.g. 1) may indicate an SCG. The index field may indicate the index of the MCG (e.g. L1/L2 MCG) or SCG (e.g. L1/L2 SCG). The size of the flag1 field may be 2 bits. The flag1 field set to 01 may mean that activation or deactivation is indicated for each of an SpCell and SCell(s) (e.g. SCell(s) belonging to an SCell list) in the MCG (or SCG) corresponding to the MCG index (or SCG index). The activation or deactivation for each CC may be indicated by a 1-bit indicator. For example, the 1-bit indicator set to a first value (0) may indicate deactivation of a CC associated with the 1-bit indicator, and the 1-bit indicator set to a second value (1) may indicate activation of a CC associated with the 1-bit indicator.

When the flag field indicates the MCG, the MCG index indicated by the index field is the same as the index of the currently serving MCG, and the flag1 field is set to 01, the UE may activate or deactivate each of all SpCells and all SCells within the current MCG based on each value of the action fields (e.g. SpCell action field and SCell action fields). When the flag field indicates the MCG, the MCG index indicated by the index field is different from the index of the currently serving MCG, and the flag1 field is set to 01, the UE may activate or deactivate each of all SpCells and all SCells within the MCG having the MCG index indicated by the index field based on each value of the action fields (e.g. SpCell action field and SCell action fields).

Referring to FIG. 11L, an L1/L2 MAC CE 1C may be a DL MAC CE. One bit among reserved bits included in a MAC SH of the L1/L2 MAC CE IC may be used to indicate an inter-cell switching command. In the L1/L2 MAC CE IC, a C-RNTI field, flag field, index field, and flag1 field may be located after the MAC SH. The C-RNTI field may indicate a C-RNTI in the current serving MCG. The flag field may indicate that an index indicated by the index field is an MCG index or SCG index. For example, the flag field set to a first value (e.g. 0) may indicate an MCG, and the flag field set to a second value (e.g. 1) may indicate an SCG. The index field may indicate an index of the MCG (e.g. L1/L2 MCG) or the SCG (e.g. L1/L2 SCG). The size of the flag1 field may be 2 bits. The flag1 field set to 11 may mean that activation of an SpCell and SCell(s) (e.g. SCell(s) belonging to an SCell list) in the MCG (or SCG) corresponding to the MCG index (or SCG index) is indicated.

When the flag field indicates the MCG, the MCG index indicated by the index field is the same as the index of the currently serving MCG, and the flag1 field is set to 11, the UE may activate all SpCells and all SCells in the current MCG. When the flag field indicates the MCG, the MCG index indicated by the index field is different from the index of the currently serving MCG, and the flag1 field is set to 11, the UE may identify that all SpCells and all SCells within an MCG having an MCG index indicated by the index field are to be activated.

Referring to FIG. 11M, an L1/L2 MAC CE 2A may be a UL MAC CE. The UL MAC CE may be a MAC CE transmitted by the UE to the base station (e.g. DU). The L1/L2 MAC CE 2A may have a meaning corresponding to the L1/L2 MAC CE 1A. One bit among reserved bits included in a MAC SH of the L1/L2 MAC CE 2A may be used to indicate completion of inter-cell switching (e.g. completion of inter-cell mobility).

Referring to FIG. 11N, an L1/L2 MAC CE 2B may be a UL MAC CE. The L1/L2 MAC CE 2B may have a meaning corresponding to the L1/L2 MAC CE 1B. One bit among reserved bits included in a MAC SH of the L1/L2 MAC CE 2B may be used to indicate completion of inter-cell switching.

Referring to FIG. 11O, an L1/L2 MAC CE 2C may be a UL MAC CE. The L1/L2 MAC CE 2C may have a meaning corresponding to the L1/L2 MAC CE IC. One bit among reserved bits included in a MAC SH of the L1/L2 MAC CE 2C may be used to indicate completion of inter-cell switching.

Procedures for Case A (e.g. PP1-1, PP2)

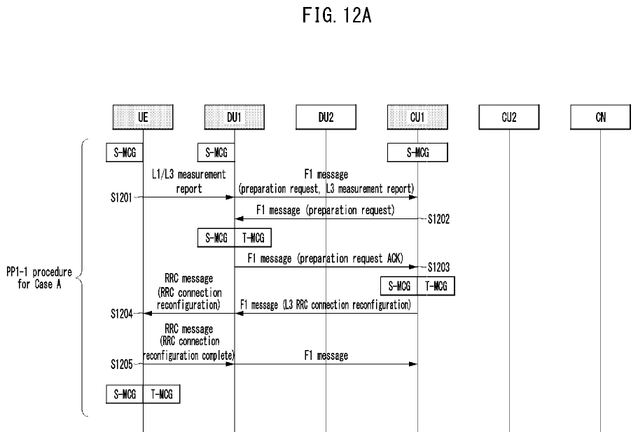

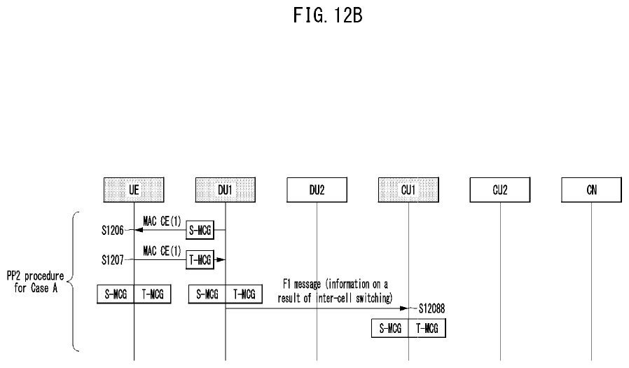

FIG. 12A is a sequence chart illustrating a PP1-1 procedure in Case A of FIG. 1, and FIG. 12B is a sequence chart illustrating a PP2 procedure in Case A of FIG. 1.

Referring to FIGS. 12A and 12B, the exemplary embodiment of FIG. 12A (e.g. PP1-1 procedure) may be performed first, and the exemplary embodiment of FIG. 12B (e.g. PP2 procedure) may be performed after the exemplary embodiment of FIG. 12A. A preparation procedure and/or execution procedure for two CellGs (e.g. S-MCG, T-MCG) may be performed in a DU1. The preparation procedure and/or execution procedure may be a procedure for inter-cell switching (e.g. inter-cell mobility).

In the exemplary embodiment of FIG. 12A (e.g. PP1-1 procedure in Case A), a UE, DU1, and CU1 may initially have configuration information for the S-MCG. In a step S1201, the UE may transmit measurement information (e.g. L1/L3 measurement information, L1/L3 measurement report) to the DU1, the DU1 may receive the measurement information from the UE, the DU1 may transmit an F1 message including the measurement information to the CU1, and the CU1 may receive the F1 message from the DU1. The F1 message may request a pre-preparation procedure for the T-MCG (e.g. T-MCG configuration). In other words, the F1 message may indicate (or request) to perform the pre-preparation procedure for the inter-cell mobility procedure. In the pre-preparation procedure for the inter-cell mobility procedure, the T-MCG (e.g. T-MCG for the DU1 and/or UE) may be configured. The inter-cell mobility procedure may refer to an inter-cell switching procedure.

The L1 measurement information may be reported periodically. Alternatively, the L1 measurement information may be reported when an event occurs. The L1 measurement information reported according to the occurrence of the event may be referred to as an event-based L1 measurement report (or event-based L1 measurement information). The L1 measurement information may be included in the F1 message for preparation request. The L3 measurement information may be reported periodically. Alternatively, the L3 measurement information may be reported when an event occurs. The L3 measurement information may be included in an F1 message (e.g. RRC measurement report) for RRC transfer.

The CU1 may determine whether to perform the pre-preparation procedure for the T-MCG based on information element(s) included in the F1 message. If the pre-preparation procedure for the T-MCG is required, the CU1 may transmit the F1 message for preparation request to the DU1 (S1202). In other words, the F1 message may indicate to perform the pre-preparation procedure for the inter-cell mobility procedure. The DU1 may receive the F1 message from the CU1 and identify that the pre-preparation procedure is requested based on the F1 message. The DU1 may transmit an F1 message, which is acknowledgement (ACK) for the preparation request, to the CU 1 (S1203). The CU1 may identify ACK for the preparation request by receiving the F1 message from the DU1. By performing the steps S1202 and S1203, required prior information related to the T-MCG (e.g. information required for configuring the T-MCG) may be configured between the DU1 and the CU1. In other words, at least one of the F1 message in the step S1202 or the F1 message in the step S1203 may include information element(s) required for configuring the T-MCG. By the above-described operations, the pre-preparation procedure may be performed in NW. In other words, by the above-described operations, the T-MCG may be configured between the DU1 and the CU1.

In a step S1204, the CU1 may prepare T-MCG prior information (e.g. T-MCG configuration information) required for the UE, and may transmit an F1 message including the T-MCG prior information to the DU1, the DU1 may receive the F1 message from the CU1, the the T-MCG prior information to the UE, and the UE may receive the RRC message from the DU1. The UE may perform a configuration procedure (e.g. pre-configuration procedure) for the T-MCG based on the T-MCG prior information included in the RRC message. The F1 message may be used for transmission of the RRC message (e.g. information element(s) included in the RRC message).

In a step S1205, the UE may transmit an RRC message (e.g. RRC connection reconfiguration complete message) to the DU1 when configuration (e.g. pre-configuration) for the T-MCG is completed, the DU1 may receive the RRC message from the UE, the DU1 may transmit an F1 message related to the RRC message to the CU1, and the CU1 may receive the F1 message from the DU1. In the step S1205, the RRC connection reconfiguration complete message and/or the F1 message may indicate that the configuration of the T-MCG has been completed. When the F1 message is received, the CU1 may determine that configuration (e.g. pre-configuration) for the T-MCG has been completed in the UE. The F1 message may be used for transmission of the RRC message (e.g. information element(s) included in the RRC message).

According to the above-described operations, the S-MCG and the T-MCG may be configured for the UE. In other words, the UE may have information (e.g. all information) about the S-MCG and the T-MCG. By performing the PP1-1 procedure in Case A, the UE may have configuration information (e.g. related information) for the S-MCG and T-MCG related to the UE, the DU1 may have configuration information (e.g. related information) for the S-MCG and T-MCG related to the DU1, and the CU1 may have configuration information (e.g. related information) for the S-MCG and T-MCG related to the CU1.

In the exemplary embodiment of FIG. 12B (e.g. PP2 procedure in Case A), the inter-cell mobility procedure may be triggered based on periodic L1 measurement report(s) or event-based L1 measurement report(s). In other words, if triggering condition(s) of the inter-cell mobility procedure are satisfied based on periodic L1 measurement report(s) or event-based L1 measurement report(s), the inter-cell mobility procedure may be triggered. In this case, the DU1 may transmit a MAC CE 1 to the UE through the S-MCG (S1206). The MAC CE 1 may indicate to perform the inter-cell mobility procedure. The MAC CE 1 may include an information element indicating activation for the S-MCG (e.g. a CC of the S-MCG). The UE may receive the MAC CE 1 from the DU1. Upon receiving the MAC CE 1, the UE may determine that the inter-cell mobility procedure is to be performed. Therefore, the UE may perform the inter-cell mobility procedure. For example, the UE may change the PCell from the S-MCG to the T-MCG (e.g. T-MCG preconfigured by the PP1-1 procedure).

After the PCell change is completed, the UE may transmit a MAC CE 2 to the DU1 through the T-MCG (S1207). The MAC CE 2 may include an information element indicating deactivation for the S-MCG (e.g. a CC of the S-MCG). The MAC CE 2 may be a response (e.g. ACK) to the MAC CE 1. The MAC CE 2 may indicate that the inter-cell mobility procedure has been completed (e.g. performed). In this case, an SpCell corresponding to the UE's PCell may be configured in the T-MCG. In other words, when the MAC CE1 1 is received, the UE may perform the inter-cell mobility procedure (e.g. inter-cell switching procedure). The DU1 may receive the MAC CE 2 through the T-MCG. In this case, the DU1 may determine that the SpCell corresponding to the PCell is configured in the T-MCG. The DU1 may transmit an F1 message including information on a result of the inter-cell switching (e.g. information on a result of the inter-cell mobility) to the CU1 (S1208). The CU1 may receive the F1 message from the DU1 and identify the information on the result of the inter-cell switching, which is included in the F1 message. The CU1 may recognize that the SpCell corresponding to the PCell is configured in the T-MCG.

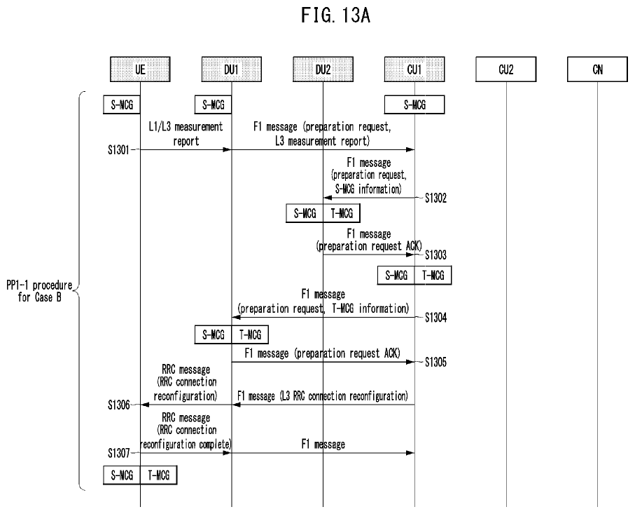

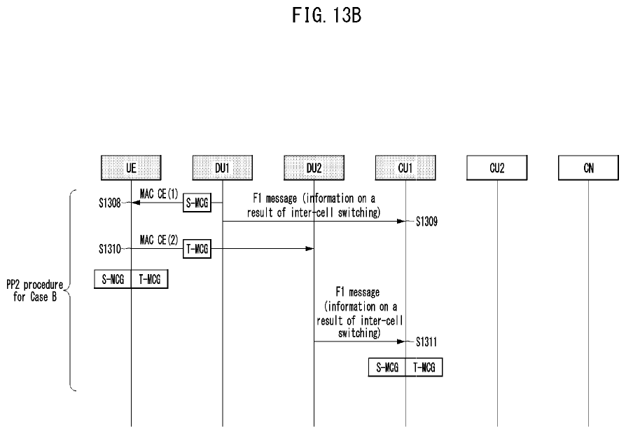

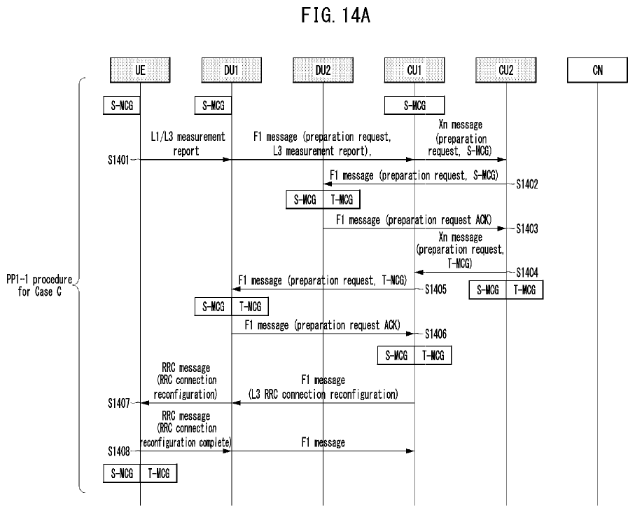

FIG. 13A is a sequence chart illustrating a PP1-1 procedure in Case B of FIG. 1, and FIG. 13B is a sequence chart illustrating a PP2 procedure in Case B of FIG. 1.

Referring to FIGS. 13A and 13B, the exemplary embodiment of FIG. 13A (e.g. PP1-1 procedure) may be performed first, and the exemplary embodiment of FIG. 13B (e.g. PP2 procedure) may be performed after the exemplary embodiment of FIG. 13A. A pre-configuration procedure for an S-MCG may be required in a DU1 and a pre-configuration procedure for a T-MCG may be required in a DU2. The DU1 and DU2 may be connected to the same CU1, and a preparation procedure for the T-MCG may be performed. In addition, a preparation procedure and/or execution procedure for cell groups (e.g. S-MCG, T-MCG) may be performed. The preparation procedure and/or execution procedure may be a procedure for inter-cell switching.

In the exemplary embodiment of FIG. 13A (e.g. PP1-1 procedure in case B), a UE, DU1, and CU1 may initially have configuration information for the S-MCG. In a step S1301, the UE may transmit measurement information (e.g. L1/L3 measurement information, L1/L3 measurement report) to the DU1, the DU1 may receive the measurement information from the UE, the DU1 may transmit an F1 message including the measurement information to the CU1, and the CU1 may receive the F1 message from the DU1. The F1 message may request a pre-preparation procedure for the T-MCG. In other words, the F1 message may indicate to perform the pre-preparation procedure of the inter-cell mobility procedure.

The L1 measurement information may be reported periodically. Alternatively, the L1 measurement information may be reported when an event occurs. L1 measurement information may be included in the F1 message for preparation required. The L3 measurement information may be reported periodically. Alternatively, the L3 measurement information may be reported when an event occurs. The L3 measurement information may be included in an F1 message (e.g. RRC measurement report) for RRC transfer.

The CU1 may determine whether to perform the pre-preparation procedure for the T-MCG based on information element(s) included in the F1 message. If the pre-preparation procedure for the T-MCG is required, the CU1 may transmit the F1 message for preparation request to the DU1 (S1302). The F1 message may include information (e.g. configuration information) of the S-MCG and/or T-MCG. The DU2 may receive the F1 message from the CU1 and identify that the preparation procedure is requested based on the F1 message. In addition, the DU2 may identify the information of the S-MCG and/or T-MCG included in the F1 message, and configure the S-MCG and/or T-MCG. The DU2 may transmit an F1 message, which is an ACK for the preparation request, to the CU1 (S1303). The CU1 may identify the ACK for the preparation request by receiving the F1 message from the DU2. By performing the steps S1302 and S1303, required prior information related to the S-MCG and/or T-MCG may be configured between the DU2 and CU1. For example, the DU2 may obtain information (e.g. configuration information) of the S-MCG and/or T-MCG. By the above-described operations, the pre-preparation procedure may be performed in NW.

If pre-preparation for the T-MCG is required, the CU1 may transmit an F1 message to the DU1 for preparation request (S1304). The F1 message may include information (e.g. configuration information) of the T-MCG. The information of the T-MCG transmitted in the step S1304 may be information of the T-MCG for the DU2. Alternatively, the information of the T-MCG transmitted in the step S1304 may be information of the T-MCG for the DU1. In other words, the T-MCG for the DU1 and the T-MCG for the DU2 may be configured independently. The DU1 may receive the F1 message from the CU1 and identify that the preparation procedure is requested based on the F1 message. The DU1 may transmit an F1 message, which is an ACK for the preparation request, to the CU1 (S1305). The CU1 may identify the ACK for the preparation request by receiving the F1 message from the DU1. By performing the steps S1304 and S1305, required prior information related to the T-MCG may be configured between the DU1 and CU1. By the above-described operations, the pre-preparation procedure may be performed in NW.

In a step S1306, the CU1 may prepare T-MCG prior information required for the UE and transmit an F1 message including the T-MCG prior information (e.g. T-MCG prior information for the DU2) to the DU1, the DU1 may receive the F1 message from the CU1, the the T-MCG prior information to the UE, and the UE may receive the RRC message from the DU1. The UE may perform a configuration procedure (e.g. pre-configuration procedure) for the T-MCG based on the T-MCG prior information included in the RRC message. The F1 message may be used for transmission of an RRC message (e.g. information element(s) included in the RRC message).

In a step S1307, the UE may transmit an RRC message (e.g. RRC connection reconfiguration complete message) to the DU1 when configuration (e.g. pre-configuration) for the T-MCG is completed, the DU1 may receive the RRC message from the UE, the DU1 may transmit an F1 message related to the RRC message to the CU1, and the CU1 may receive the F1 message from the DU1. When the F1 message is received, the CU1 may determine that configuration (e.g. pre-configuration) for the T-MCG has been completed in the UE. The F1 message may be used for transmission of the RRC message (e.g. information element(s) included in the RRC message).

According to the above-described operations, the S-MCG and T-MCG may be configured for the UE. In other words, the UE may have information (e.g. all information) about the S-MCG and T-MCG. By performing the PP1-1 procedure in Case B, the UE may have configuration information (e.g. related information) for the S-MCG and T-MCG related to the UE, the DU1 may have configuration information (e.g. related information) for the S-MCG and T-MCG related to the DU1, the DU2 may have configuration information (e.g. related information) for the S-MCG and T-MCG related to the DU2, and the CU1 may have configuration information (e.g. related information) for the S-MCG and T-MCG related to the CU1.

In the exemplary embodiment of FIG. 13B (e.g. PP2 procedure in Case B), the inter-cell mobility procedure may be triggered based on periodic L1 measurement report(s) or event-based L1 measurement report(s). In other words, if triggering condition(s) of the inter-cell mobility procedure are satisfied based on periodic L1 measurement report(s) or event-based L1 measurement report(s), the inter-cell mobility procedure may be triggered. In this case, the DU1 may transmit a MAC CE 1 to the UE through the S-MCG (S1308). The MAC CE 1 may include an information element indicating activation of the T-MCG of the DU2 (e.g. a CC of the T-MCG). The UE may receive the MAC CE 1 from the DU1. The DU1 may transmit an F1 message including information on a result of the inter-cell switching to the CU1 (S1309). The CU1 may receive the F1 message from the DU1 and identify information on the result of the inter-cell switching in the F1 message.

When the MAC CE 1 is received, the UE may transmit a MAC CE 2 to the DU2 through the T-MCG (S1310). The MAC CE 2 may be a response (e.g. ACK) to the MAC CE 1. In this case, an SpCell corresponding to the UE's PCell may be configured in the T-MCG. In other words, when the MAC CE1 1 is received, the UE may perform an inter-cell mobility procedure (e.g. inter-cell switching procedure). By the inter-cell mobility procedure, the UE's PCell may be changed from the S-MCG of the DU1 to the T-MCG of the DU2. The DU2 may receive the MAC CE 2 through the T-MCG. In this case, the DU2 may determine that the SpCell corresponding to the PCell is configured in the T-MCG. The DU2 may transmit an F1 message including information on a result of the inter-cell switching to the CU1 (S1311). The CU1 may receive the F1 message from the DU2 and identify the information on the result of the inter-cell switching included in the F1 message. When an F1 message including information on a result of the inter-cell switching is received from the DU1 and/or DU2, the CU1 may recognize that the SpCell corresponding to the PCell is configured (e.g. changed) to the T-MCG.

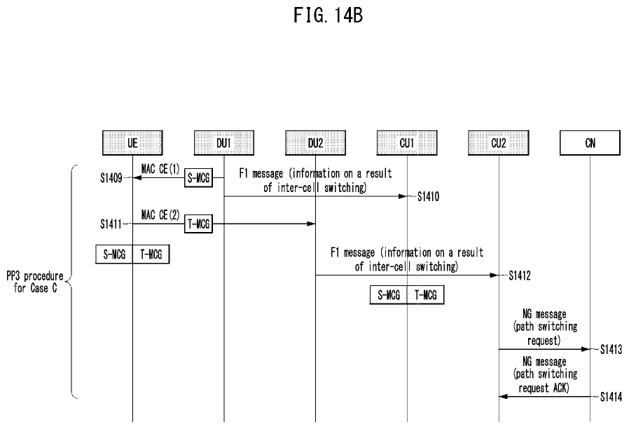

FIG. 14A is a sequence chart illustrating a PP1-1 procedure in Case C of FIG. 1, and FIG. 14B is a sequence chart illustrating a PP3 procedure in Case C of FIG. 1.

Referring to FIGS. 14A and 14B, the exemplary embodiment of FIG. 14A (e.g. PP1-1 procedure) may be performed first, and the exemplary embodiment of FIG. 14B (e.g. PP3 procedure) may be performed after the exemplary embodiment of FIG. 14A. A pre-configuration procedure for an S-MCG may be required in a DU1 and a pre-configuration procedure for a T-MCG may be required in a DU2. The DU1 and DU2 may be connected to different CUs. For example, the DU1 may be connected to the CU1, and the DU2 may be connected to the CU2. A preparation procedure for the T-MCG may be performed. In addition, a preparation procedure and/or execution procedure for cell groups (e.g. S-MCG, T-MCG) may be performed. The preparation procedure and/or execution procedure may be a procedure for inter-cell switching.

In the exemplary embodiment of FIG. 14A (e.g. PP1-1 procedure in Case C), a UE, DU1, and CU1 may initially have configuration information for the S-MCG. In a step S1401, the UE may transmit measurement information (e.g. L1/L3 measurement information, L1/L3 measurement report) to the DU1, the DU1 may receive the measurement information from the UE, the DU1 may transmit an F1 message including the measurement information to the CU1, and the CU1 may receive the F1 message from the DU1. The F1 message may request a pre-preparation procedure for the T-MCG. In other words, the F1 message may indicate to perform the pre-preparation procedure of the inter-cell mobility procedure.

The L1 measurement information may be reported periodically. Alternatively, the L1 measurement information may be reported when an event occurs. L1 measurement information may be included in the F1 message for preparation required. The L3 measurement information may be reported periodically. Alternatively, the L3 measurement information may be reported when an event occurs. The L3 measurement information may be included in an F1 message (e.g. RRC measurement report) for RRC transfer.

The CU1 may determine whether to perform the pre-preparation for the T-MCG based on information element(s) included in the F1 message. If the pre-preparation for the T-MCG is required, the CU1 may transmit an Xn message for preparation request to the CU2 (S1401). The Xn message may include information (e.g. configuration information) of the MCG and/or information of the S-MCG. The CU2 may receive the Xn message from the CU1 and identify that the pre-preparation procedure is requested based on the Xn message. In addition, the CU2 may identify the information of the T-MCG and/or S-MCG included in the Xn message.

The CU2 may transmit an F1 message for preparation request to the DU2 (S1402). The F1 message may include information (e.g. configuration information) if the T-MCG and/or S-MCG. The DU2 may receive the F1 message from the CU2 and identify that the pre-preparation procedure is requested based on the F1 message. In addition, the DU2 may identify the information of the T-MCG and/or the information of the S-MCG included in the F1 message and configure the T-MCG and/or S-MCG. The DU2 may transmit an F1 message, which is an ACK for the preparation request, to the CU2 (S1403). The CU2 may identify the ACK for the preparation request by receiving the F1 message from the DU2. The CU2 may transmit an Xn message, which is an ACK for the preparation request, to the CU1 (S1404). The Xn message may include information of the T-MCG (e.g., configuration information of the T-MCG for the DU2). The CU1 may receive the Xn message from the CU2 and identify the information of the T-MCG included in the Xn message.

By performing the steps S1402 to S1404, required prior information related to the S-MCG and/or T-MCG may be configured between the DU2 and CU2. For example, the DU2 may obtain information (e.g. configuration information) of the S-MCG and/or T-MCG. By the above operations, the pre-preparation procedure may be performed in NW.

If pre-preparation for the T-MCG is required, the CU1 may transmit an F1 message for preparation request to the DU1 (S1405). The F1 message may include information (e.g. configuration information) of the T-MCG. The information of the T-MCG included in the F1 message may be information of the T-MCG or information of the T-MCG for the DU1, which is received from the CU2. The DU1 may receive the F1 message from the CU1 and identify that the preparation procedure is requested based on the F1 message. The DU1 may transmit an F1 message, which is an ACK for the preparation request, to the CU 1 (S1406). The CU1 may identify the ACK for the preparation request by receiving the F1 message from the DU1. By performing the steps S1405 and S1406, required prior information related to the T-MCG (e.g., T-MCG for the DU2) may be configured between the DU1 and CU1. By the above operations, the pre-preparation procedure may be performed in NW.

In a step S1407, the CU1 may prepare T-MCG prior information required for the UE, transmit an F1 message including the T-MCG prior information to the DU1, the DU1 may receive the F1 message from the CU1, the DU1 may transmit an RRC message (e.g. RRC connection reconfiguration message) including the T-MCG prior information to the UE, and the UE may receive the RRC message from the DU1. The UE may perform a configuration procedure (e.g. pre-configuration procedure) for the T-MCG based on the T-MCG prior information included in the RRC message. The F1 message may be used for transmission of the RRC message (e.g. information element(s) included in the RRC message).

In a step S1408, the UE may transmit an RRC message (e.g., RRC connection reconfiguration complete message) to the DU1 when configuration (e.g., pre-configuration) for the T-MCG is completed, the DU1 may receive the RRC message from the UE, the DU1 may transmit an F1 message related to the RRC message to the CU1, and the CU1 may receive the F1 message from DU1. When the F1 message is received, the CU1 may determine that configuration (e.g. pre-configuration) for the T-MCG has been completed in the UE. The F1 message may be used for transmission of the RRC message (e.g. information element(s) included in the RRC message).

According to the above-described operations, the S-MCG and the T-MCG may be configured for the UE. In other words, the UE may have information (e.g. all information) about the S-MCG and the T-MCG. By performing the PP1-1 procedure in Case C, the UE may have configuration information (e.g. related information) for the S-MCG and T-MCG related to the UE, the DU1/CU1 may have configuration information (e.g. related information) for the S-MCG and T-MCG related to the DU1/CU1, and the DU2/CU2 may have configuration information (e.g. related information) for the S-MCG and T-MCG related to the DU2/CU2.

In the exemplary embodiment of FIG. 14B (e.g. PP3 procedure in Case C), the inter-cell mobility procedure may be triggered based on periodic L1 measurement report(s) or event-based L1 measurement report(s). In other words, if triggering condition(s) of the inter-cell mobility procedure are satisfied based on periodic L1 measurement report(s) or event-based L1 measurement report(s), the inter-cell mobility procedure may be triggered. In this case, the DU1 may transmit a MAC CE 1 to the UE through the S-MCG (S1409). The MAC CE 1 may include an information element indicating activation of the T-MCG (e.g. a CC of the T-MCG) of the DU2. The UE may receive the MAC CE 1 from the DU1. The DU1 may transmit an F1 message including information on a result of the inter-cell switching to the CU1 (S1410). The CU1 may receive the F1 message from DU1 and identify the information on the result of the inter-cell switching included in the F1 message.

When the MAC CE 1 is received, the UE may transmit a MAC CE 2 to the DU2 through the T-MCG (S1310). The MAC CE 2 may be a response (e.g. ACK) to the MAC CE 1. In this case, an SpCell corresponding to the UE's PCell may be configured in the T-MCG. In other words, when the MAC CE1 1 is received, the UE may perform an inter-cell mobility procedure (e.g. inter-cell switching procedure). By the inter-cell mobility procedure, the UE's PCell may be changed from the S-MCG of the DU1 to the T-MCG of the DU2. The DU2 may receive the MAC CE 2 through the T-MCG. In this case, the DU2 may determine that the SpCell corresponding to the PCell is configured in the T-MCG. The DU2 may transmit an F1 message including information on a result of the inter-cell switching to the CU2 (S1412). The CU2 may receive the F1 message from the DU2 and identify the information on the result of the inter-cell switching included in the F1 message. When an F1 message including information on a result of the inter-cell switching is received from the DU1 and/or DU2, the CU2 may recognize that the SpCell corresponding to the PCell is configured (e.g. changed) to the T-MCG.

After receiving the F1 message, the CU2 may transmit an NG message to the CN requesting path switching to change a CP/UP path of the CN-CU1 to a CP/UP path of the CN-CU2 (S1413). The CN may receive the NG message from the CU2 and perform a path switching procedure. The CN may transmit an NG message, which is an ACK for the path switching request, to the CU2 (S1414). The CU2 may receive the NG message from the CN. According to the steps S1413 and S1414, the CP/UP path of CN-CU1 may be switched to the CP/UP path of CN-CU2.

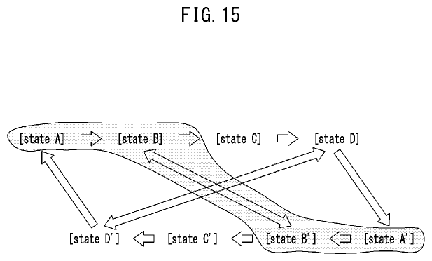

FIG. 15 is a conceptual diagram illustrating examples of states in each case.

Referring to FIG. 15, State A, State B, State C, State D, State A′, State B′, State C′, and State D′ may be defined.

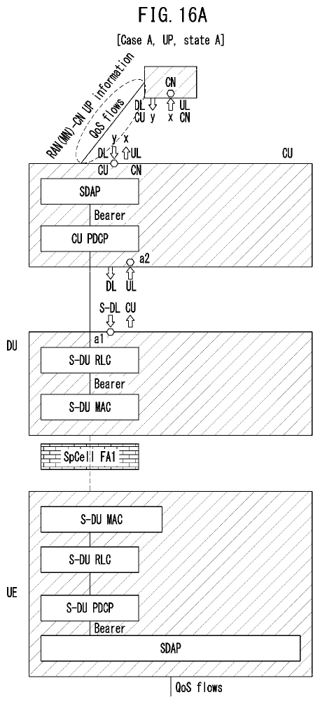

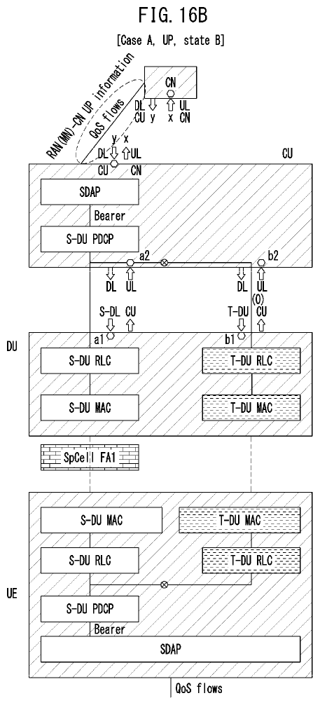

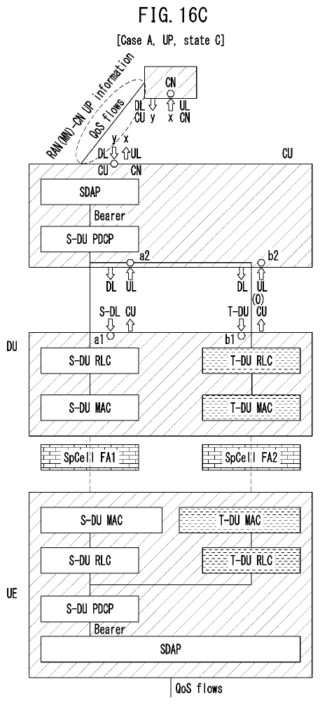

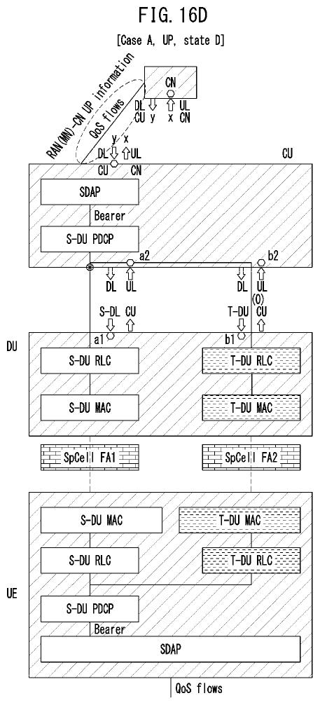

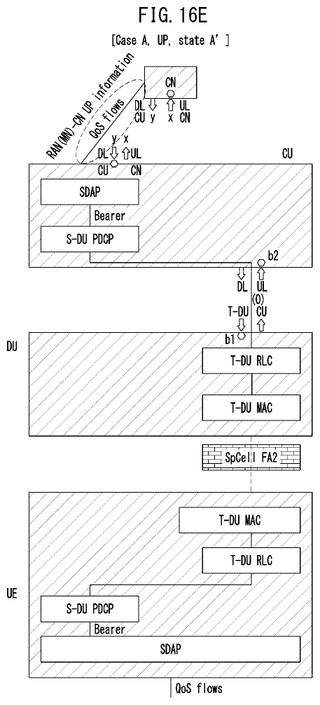

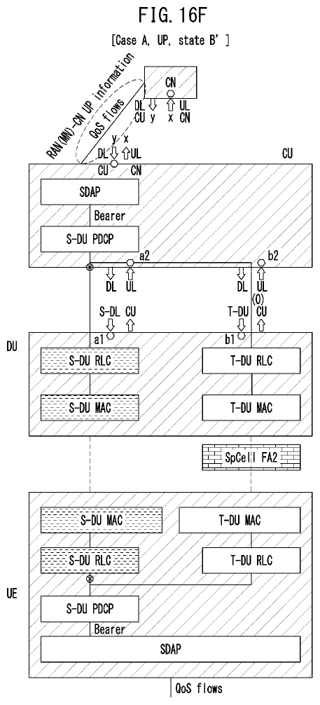

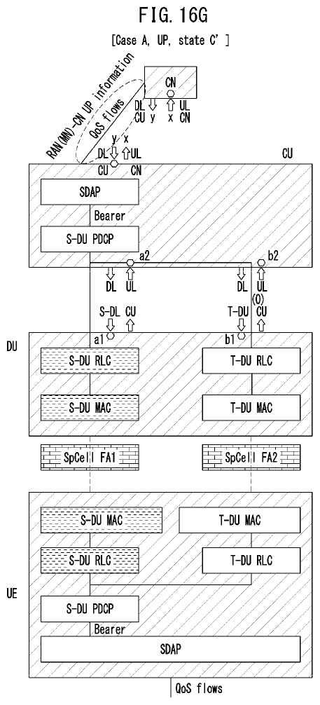

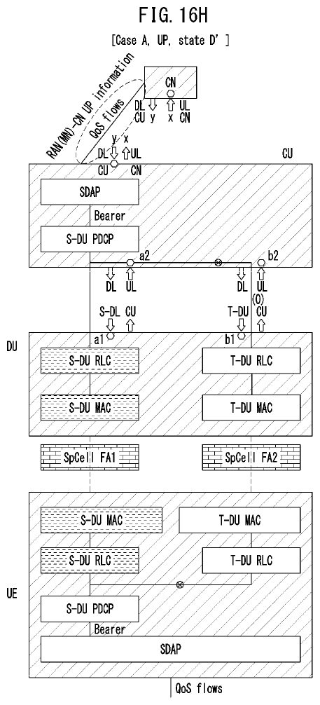

FIG. 16A is a conceptual diagram illustrating State A in Case A in terms of UP. FIG. 16B is a conceptual diagram illustrating State B in Case A in terms of UP. FIG. 16C is a conceptual diagram illustrating State C in Case A in terms of UP. FIG. 16D is a conceptual diagram illustrating State D in Case A in terms of UP. FIG. 16E is a conceptual diagram illustrating State A′ in Case A in terms of UP. FIG. 16F is a conceptual diagram illustrating State B′ in Case A in terms of UP. FIG. 16G is a conceptual diagram illustrating State C′ in Case A in terms of UP. FIG. 16H is a conceptual diagram illustrating State D′ in Case A in terms of UP.

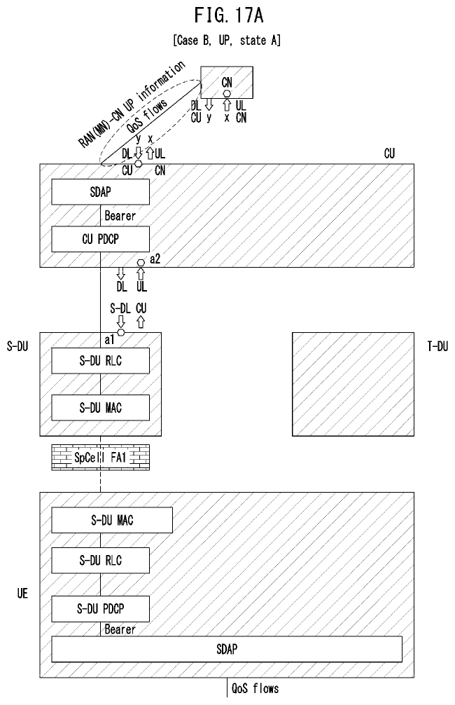

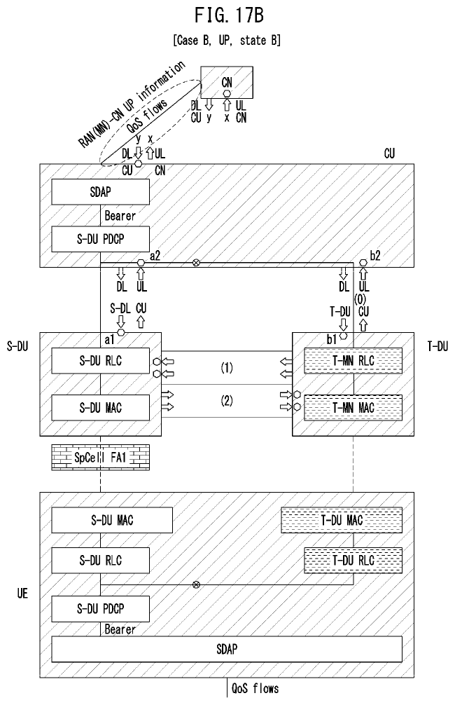

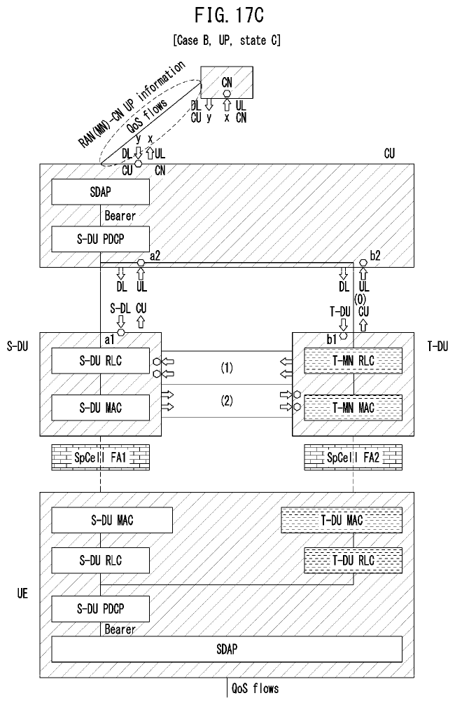

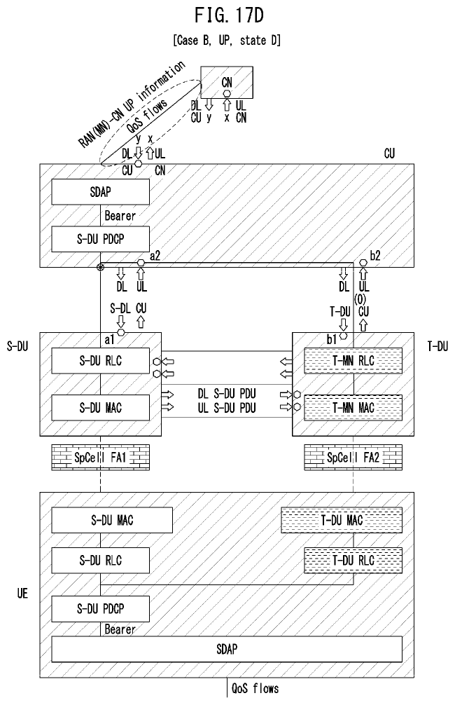

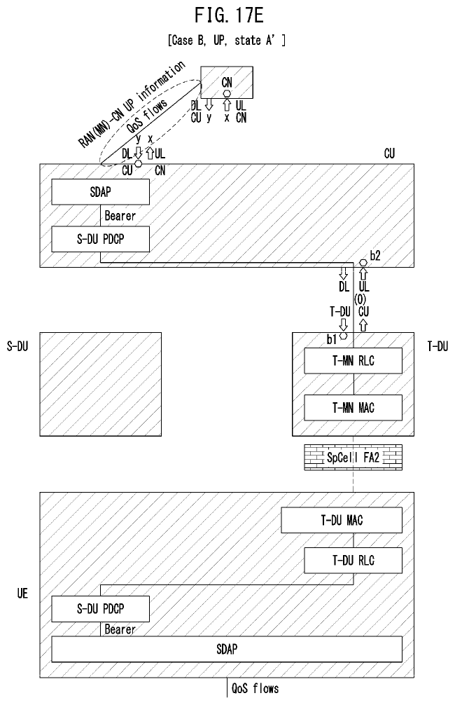

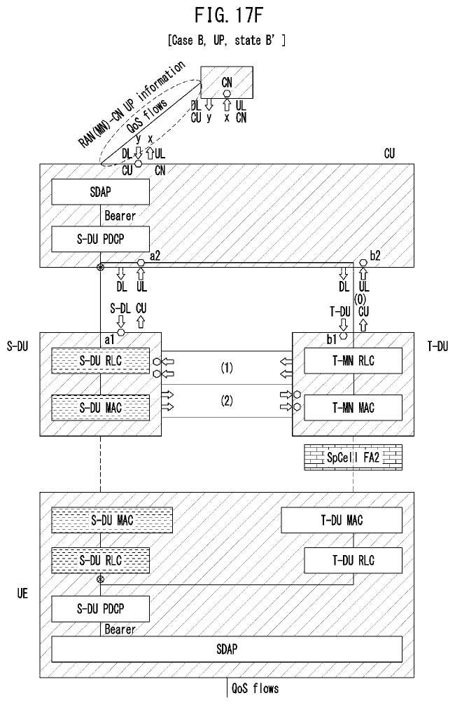

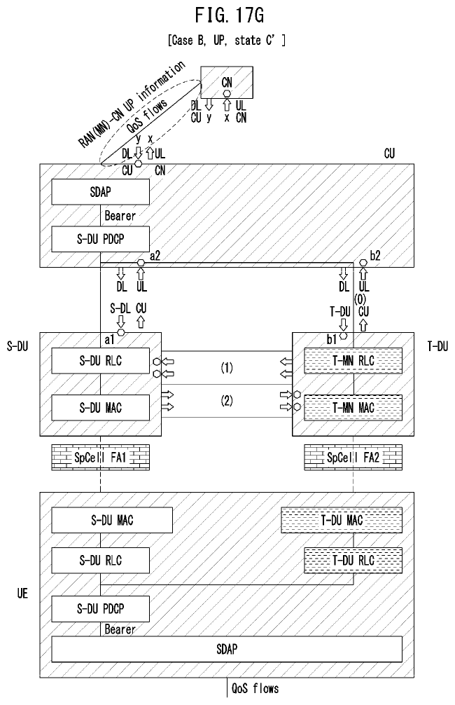

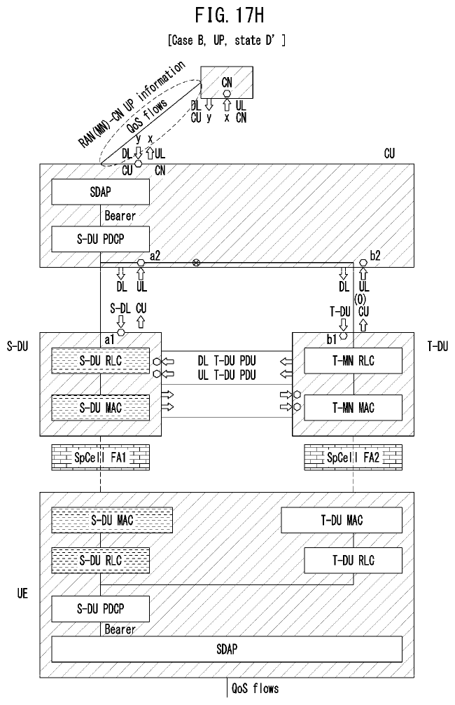

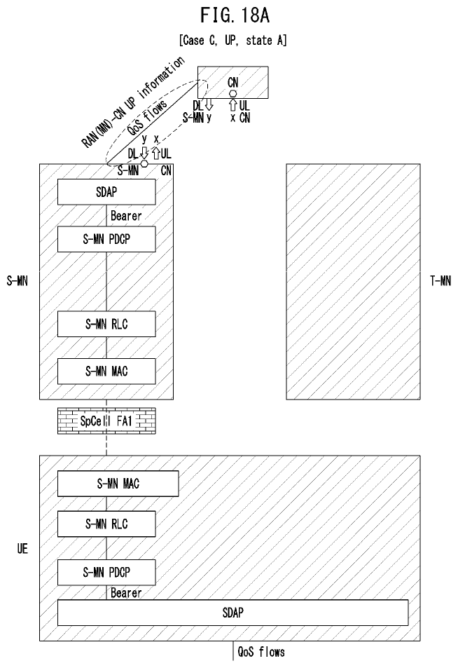

FIG. 17A is a conceptual diagram illustrating State A in Case B in terms of UP. FIG. 17B is a conceptual diagram illustrating State B in Case B in terms of UP. FIG. 17C is a conceptual diagram illustrating State C in Case B in terms of UP. FIG. 17D is a conceptual diagram illustrating State D in Case B in terms of UP. FIG. 17E is a conceptual diagram illustrating State A′ in Case B in terms of UP. FIG. 17F is a conceptual diagram illustrating State B′ in Case B in terms of UP. FIG. 17G is a conceptual diagram illustrating State C′ in Case B in terms of UP. FIG. 17H is a conceptual diagram illustrating State D′ in Case B in terms of UP.

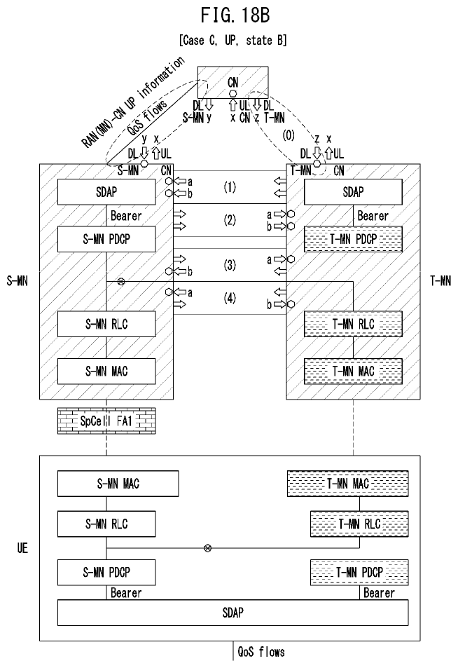

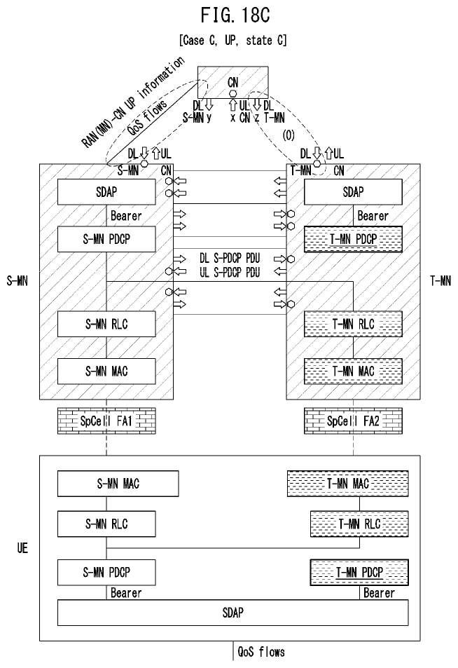

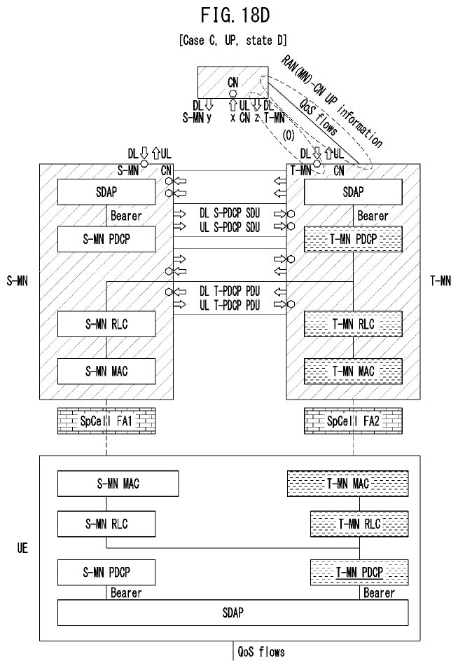

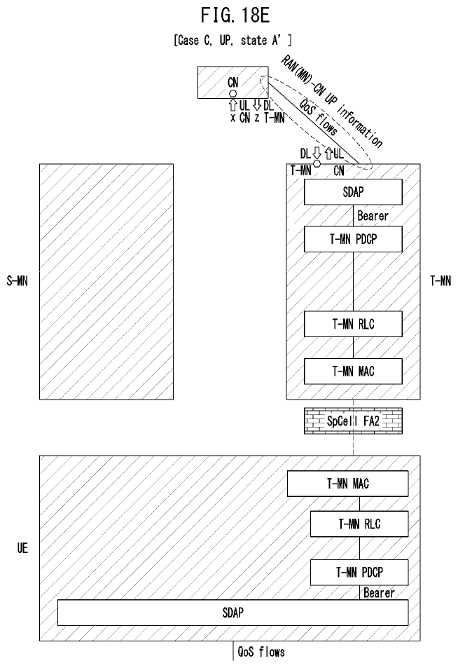

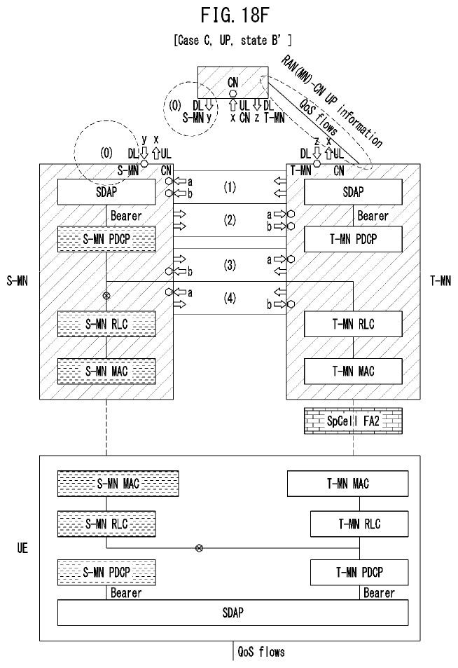

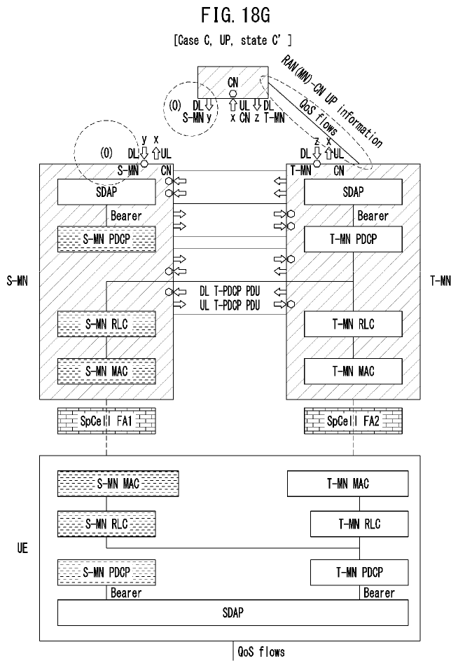

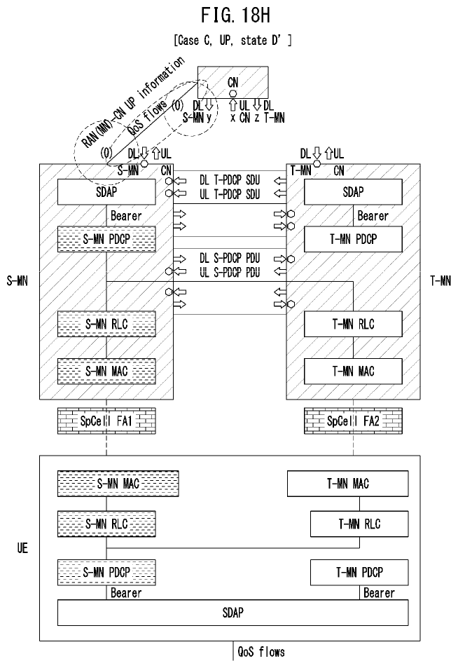

FIG. 18A is a conceptual diagram illustrating State A in Case C in terms of UP. FIG. 18B is a conceptual diagram illustrating State B in Case C in terms of UP. FIG. 18C is a conceptual diagram illustrating State C in Case C in terms of UP. FIG. 18D is a conceptual diagram illustrating State D in Case C in terms of UP. FIG. 18E is a conceptual diagram illustrating State A′ in Case C in terms of UP. FIG. 18F is a conceptual diagram illustrating State B′ in Case C in terms of UP. FIG. 18G is a conceptual diagram illustrating State C′ in Case C in terms of UP. FIG. 18H is a conceptual diagram illustrating State D′ in Case C in terms of UP.

The ‘dual SpCell horizontal mobility procedure under CA situation’ defined in FIG. 8C may correspond to State A, State B, State C, State D, State A′, State B′, State C′, and State D′ defined in FIG. 15. The ‘horizontal mobility procedure in CA situation’ defined in FIG. 8B may correspond to State A, State B, State B′, and State A′ defined in FIG. 15. In other words, in FIG. 8B, one SpCell may be configured in a certain node. Alternatively, in FIG. 8B, one PCell may be configured in a certain node.

In the PP1-1 procedure shown in FIG. 12A, FIG. 13A, and/or FIG. 14A, a UP tunnel may be established through exchange of protocol messages (e.g. preparation request, preparation request ACK). Through the above operation, a reception tunnel ID and a transport network layer (TNL) address may be determined. In the exemplary embodiment of FIG. 3, configuration information of the previous cell group(s) may be maintained by considering a ping-pong within dotted lines of two or more cell groups (e.g. two or three CellGs). In FIGS. 16A to 16H, 17A to 17H, and 18A to 18H, an entity represented using a white-backgrounded box may mean the existing entity, and an entity represented within a hatch-backgrounded box may mean an entity configured by a preparation procedure. ⊗ may mean that data transmission is prohibited on a corresponding path.

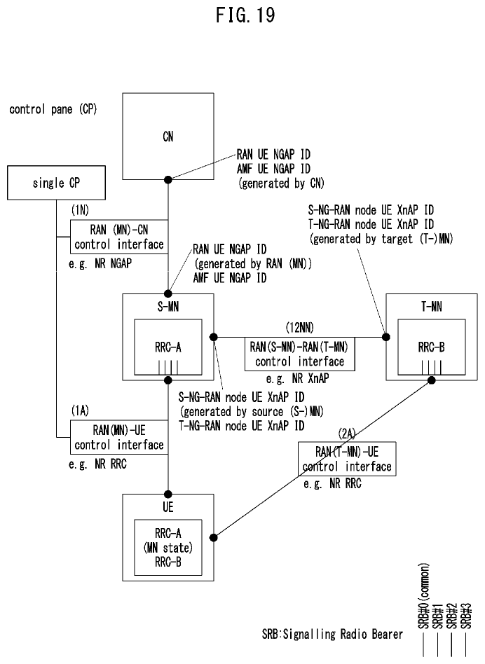

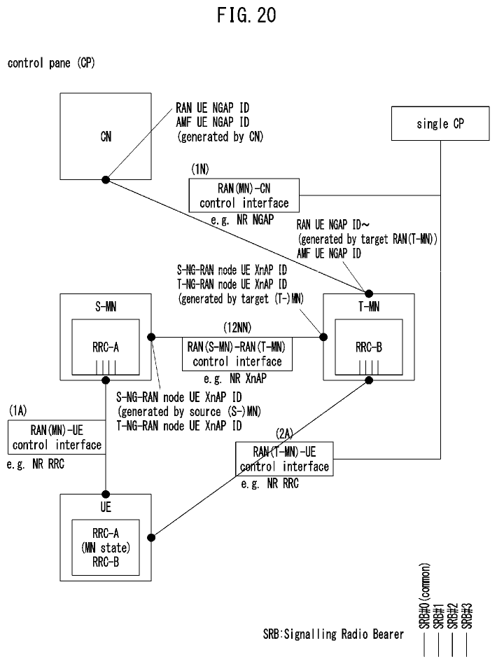

FIG. 19 is a conceptual diagram illustrating a first exemplary embodiment of a CP according to a preparation procedure in Case C, and FIG. 20 is a conceptual diagram illustrating a second exemplary embodiment of a CP according to a preparation procedure in Case C.

Referring to FIGS. 19 and 20, when NG messages (e.g. path switching request, path switching request ACK) are exchanged between the CU2 (e.g., T-MN) and the CN in FIG. 14B, the CP may be changed from the CP shown in FIG. 19 to the CP shown in FIG. 20. When NG messages (e.g., path switching request, path switching request ACK) are exchanged between the CU1 (e.g., S-MN) and the CN, the CP may be changed from the CP shown in FIG. 20 to the CP shown in FIG. 19. Previous configuration information may not be deleted from the CP. In other words, previous configuration information may be maintained in the CP. In this case, as in the exemplary embodiment of FIG. 3, in the preparation procedure for two or more cell groups (e.g., two or three CellGs), information (e.g., configuration information) of the CP and/or UP may be maintained according to a specific condition. The information of the CP and/or UP may be transitioned to the previous state or a subsequent state.

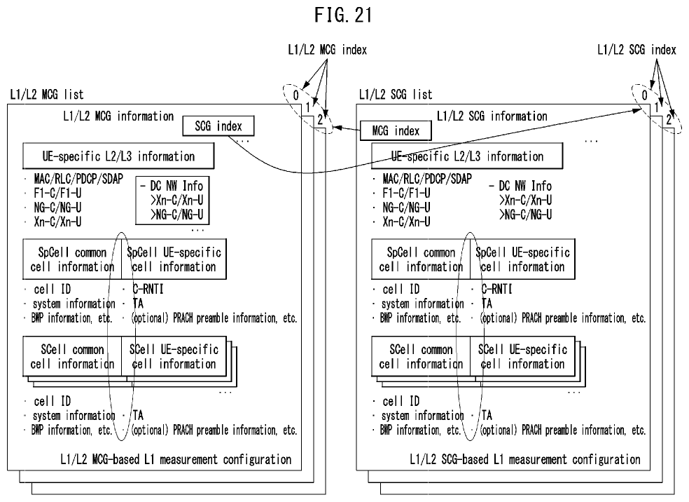

FIG. 21 is a conceptual diagram illustrating an L1/L2 MCG list and an L1/L2 SCG list.

Referring to FIG. 21, pre-configuration information for execution of an L1/L2-based inter-cell mobility procedure such as PP1 through L3-based signaling may be managed as an L1/L2 MCG list and an L1/L2 SCG list. The L1/L2 MCG list and L1/L2 SCG list may be managed independently or separately. Each L1/L2 MCG information belonging to the L1/L2 MCG list may have an SCG index, and the corresponding L1/L2 MCG information may be associated with L1/L2 SCG information corresponding to the SCG index in the L1/L2 SCG list. One L1/L2 MCG information may have multiple SCG indices. In a one-to-one DC relationship between the MCG and the SCG, the MCG and the SCG may have DU network (NW) information (e.g. CP information, MCG/SCG terminated UP information). One MCG may have multiple DC NW information.

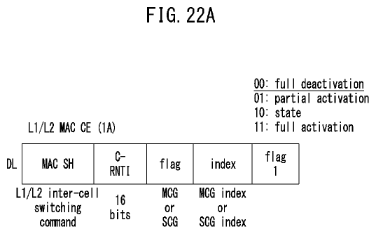

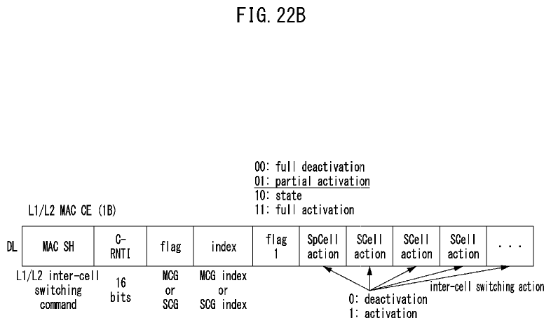

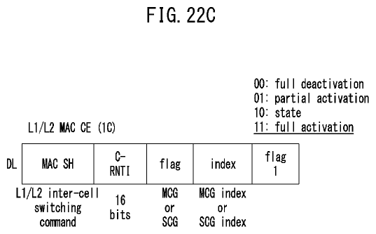

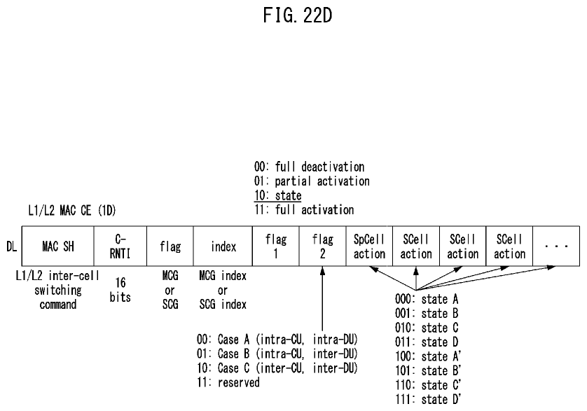

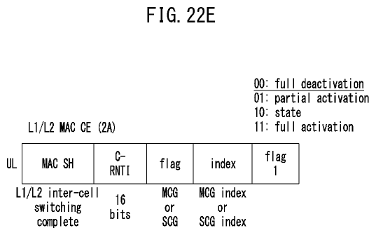

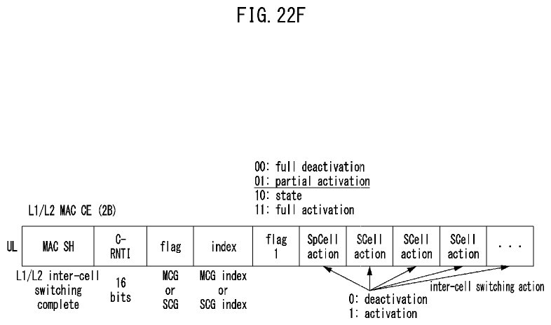

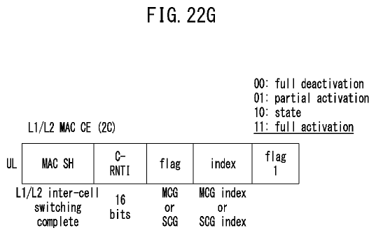

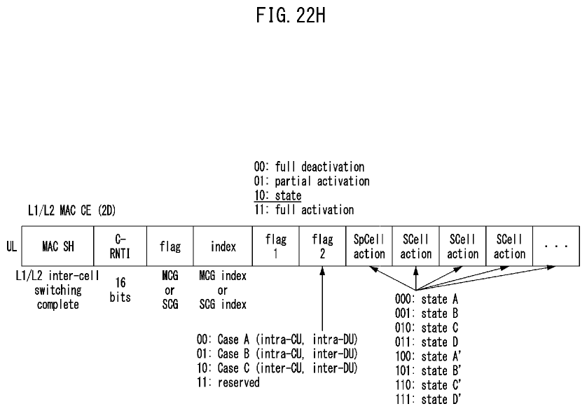

FIGS. 22A to 22D are conceptual diagrams illustrating other exemplary embodiments of the L1/L2 MAC CE 1, and FIGS. 22E to 22H are conceptual diagrams illustrating other exemplary embodiments of the L1/L2 MAC CE 2.

Referring to FIGS. 22A to 22H, the L1/L2 MAC CE 1 may be an extended exemplary embodiment of the L1/L2 MAC CE 1 shown in FIGS. 11J to 11L, and the L1/L2 MAC CE 2 may be an extended exemplary embodiment of the L1/L2 MAC CE 2 shown in FIGS. 11M to 110.

The flag1 field set to 10 may indicate a state. If the flag1 field is set to 10, a flag2 field may indicate Case A, Case B, or Case C. The size of the flag2 field may be 2 bits. For example, the flag2 field set to 00 may indicate Case A, the flag2 field set to 01 may indicate Case B, and the flag2 field set to 10 may indicate Case C.

The MAC CE may be designed considering the states (e.g. connection and/or data forwarding between entities) in each of Case A, Case B, and Case C and/or states (e.g., State A, State B, State C, State D, State A′, State B′, State C′, State D′) in FIGS. 16 to 18. The states may mean ‘an entity being set up’, ‘an entity being added’, ‘an entity being removed’, and/or ‘an operation between the NW and the UE for data forwarding between entities’. The eight states may be defined (e.g. State A, State B, State C, State D, State A′, State B′, State C′, State D′). Alternatively, four states (e.g., State A, State B, State A′, State B′) may be defined.

FIG. 12A may illustrate the PP1-1 procedure in Case A, and FIG. 12B may illustrate the PP2 procedure in Case A. FIG. 13A may illustrate the PP1-1 procedure in Case B, and FIG. 13B may illustrate the PP2 procedure in Case B. FIG. 14A may illustrate the PP1-1 procedure in case C, and FIG. 14B may illustrate the PP3 procedure in case C. The information on the result of inter-cell switching may include not only ‘L1/L2 MCG information and L1/L2 SCG information’ but also state information. In FIGS. 12 to 14, S-MCG (e.g. S-MCG information, S-MCG configuration information) may mean L1/L2 MCG information for the MCG that is the source cell, and T-MCG (e.g. T-MCG information, T-MCG configuration information) may mean L1/L2 MCG information for the MCG that is the target cell.

‘An S-MCG is configured in a certain node (e.g. DU, CU, UE)’ may mean that the certain node has L1/L2 MCG information for the source cell. ‘A T-MCG is configured in a certain node’ may mean that the certain node has L1/L2 MCG information on a target cell. ‘An S-MCG and T-MCG are configured in a certain node’ may mean that the certain node has L1/L2 MCG information for the S-MCG and L1/L2 MCG information for the T-MCG which are configured by a certain procedure.

In the P4-P5 section defined in FIG. 3 and Table 1, three L1/L2 MCGs (e.g. three L1/L2 MCG information) may exist. In other words, the UE may have three L1/L2 MCGs (e.g. three L1/L2 MCG information) in the P4-P5 section. There may be three or more L1/L2 MCGs as well as two L1/L2 MCGs for the source cell and target cell. Among L1/L2 MCGs, there may be an L1/L2 MCG related to an L1/L2 SCG.

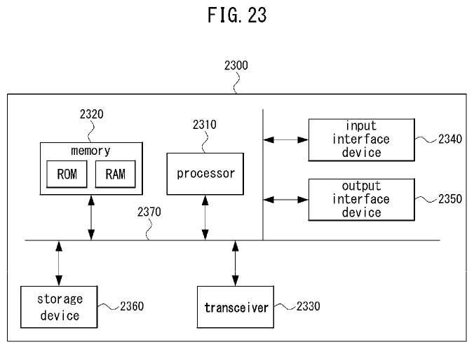

FIG. 23 is a block diagram illustrating a communication node constituting a communication network.

Referring to FIG. 23, a communication node 2300 may comprise at least one processor 2310, a memory 2320, and a transceiver 2330 connected to the network for performing communications. Also, the communication node 2300 may further comprise an input interface device 2340, an output interface device 2350, a storage device 2360, and the like. Each component included in the communication node 2300 may communicate with each other as connected through a bus 2370.

However, each component included in the communication node 2300 may not be connected to the common bus 2370 but may be connected to the processor 2310 via an individual interface or a separate bus. For example, the processor 2310 may be connected to at least one of the memory 2320, the transceiver 2330, the input interface device 2340, the output interface device 2350 and the storage device 2360 via a dedicated interface.

The processor 2310 may execute a program stored in at least one of the memory 2320 and the storage device 2360. The processor 2310 may refer to a central processing unit (CPU), a graphics processing unit (GPU), or a dedicated processor on which methods in accordance with embodiments of the present disclosure are performed. Each of the memory 2320 and the storage device 2360 may be constituted by at least one of a volatile storage medium and a non-volatile storage medium. For example, the memory 2320 may comprise at least one of read-only memory (ROM) and random access memory (RAM).

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a first distributed unit (DU), comprising:
receiving a measurement report from a user equipment (UE) through a serving (S)-master cell group (MCG) of the first DU;
transmitting a first message including the measurement report to a first central unit (CU);
performing a configuration operation of a target (T)-MCG between the first DU and the first CU; and
transmitting configuration information of the T-MCG for the first DU to the UE,
wherein the T-MCG for the first DU is configured with the UE based on the configuration information of the T-MCG.

2. The method according to claim 1, wherein the first message requests to perform a pre-preparation procedure for an inter-cell mobility procedure, and in the pre-preparation procedure, the T-MCG for the first DU is configured.

3. The method according to claim 1, wherein the performing of the configuration operation of the T-MCG between the first DU and the first CU comprises:
receiving, from the first CU, a second message indicating to perform a pre-preparation procedure for an inter-cell mobility procedure; and
transmitting a third message in response to the second message to the first CU,
wherein the T-MCG is configured by exchanging the second message and the third message, and at least one of the second message or the third message includes information element(s) required for configuring the T-MCG.

4. The method according to claim 1, wherein the transmitting of the configuration information of the T-MCG for the first DU to the UE comprises:
receiving, from the first CU, a fourth message including the configuration information of the T-MCG; and
transmitting a first radio resource control (RRC) message including the configuration information of the T-MCG to the UE,
wherein the first RRC message is an RRC connection reconfiguration message.

5. The method according to claim 1, further comprising:
receiving, from the UE, a second RRC message indicating that the configuration of the T-MCG is complete; and
transmitting, to the first CU, a fifth message indicating that the configuration of the T-MCG is completed,
wherein the second RRC message is an RRC connection reconfiguration complete message.

6. The method according to claim 1, further comprising:
in response to satisfying a triggering condition of an inter-cell mobility procedure, transmitting, to the UE, a first medium access control (MAC) control element (CE) indicating to perform the inter-cell mobility procedure; and
receiving, from the UE, a second MAC CE indicating that the inter-cell mobility procedure is completed.

7. The method according to claim 6, wherein the first MAC CE is transmitted through the S-MCG of the first DU, and the second MAC CE is received through the T-MCG of the first DU.

8. The method according to claim 6, further comprising: in response to that the inter-cell mobility procedure is completed, transmitting, to the first CU, a sixth message including information on a result of the inter-cell mobility procedure.

9. A method of a first central unit (CU), comprising:
receiving a first message including a measurement report of a user equipment (UE) from a first distributed unit (DU) to which the UE is connected;
performing a configuration operation of a target (T)-master cell group (MCG) between a second DU and the first CU; and
transmitting configuration information of the T-MCG for the second DU to the UE through the first DU,
wherein the T-MCG for the second DU is configured with the UE based on the configuration information of the T-MCG.

10. The method according to claim 9, wherein the first DU and the second DU are connected to the first CU, and a cell to which the UE is connected is changed from a cell of the first DU to a cell of the second DU by an inter-cell mobility procedure.

11. The method according to claim 9, wherein the first message requests to perform a pre-preparation procedure for an inter-cell mobility procedure, and in the pre-preparation procedure, the T-MCG for the second DU is configured.

12. The method according to claim 9, wherein the performing of the configuration operation of the T-MCG between the second DU and the first CU comprises:
transmitting, to the second DU, a second message indicating to perform a pre-preparation procedure for an inter-cell mobility procedure; and
receiving, from the second DU, a third message in response to the second message,
wherein the T-MCG is configured by exchanging the second message and the third message, and at least one of the second message or the third message includes information element(s) required for configuring the T-MCG.

13. The method according to claim 9, wherein the transmitting of the configuration information of the T-MCG for the second DU to the UE through the first DU comprises: transmitting a fourth message including the configuration information of the T-MCG to the first DU, wherein a first radio resource control (RRC) message including the configuration information of the T-MCG is transmitted from the first DU to the UE, and the first RRC message is an RRC connection reconfiguration message.

14. The method according to claim 9, further comprising: receiving, from the first DU, a fifth message indicating that the configuration of the T-MCG of the UE is completed.

15. The method according to claim 9, further comprising:
receiving, from the first DU, a sixth message indicating that an inter-cell mobility procedure is completed; and
receiving, from the second DU, a seventh message indicating that the inter-cell mobility procedure is completed,
wherein the inter-cell mobility procedure is triggered by the first DU.

16. A method of a second central unit (CU), comprising:
receiving, from a first CU, a first message requesting to perform a pre-preparation procedure for an inter-cell mobility procedure;
performing a configuration operation of a target (T)-master cell group (MCG) between a second DU and the second CU; and
transmitting configuration information of the T-MCG for the second DU to the first CU,
wherein the T-MCG for the second DU is configured with a user equipment (UE) based on the configuration information of the T-MCG.

17. The method according to claim 16, wherein the second DU is connected to the second CU, the first DU is connected to the first CU, and a cell to which the UE is connected is changed by the inter-cell mobility procedure from a cell of the first DU to a cell of the second DU.

18. The method according to claim 16, wherein the performing of the configuration operation of the T-MCG between the second DU and the second CU comprises:
transmitting, to the second DU, a second message indicating to perform the pre-preparation procedure for the inter-cell mobility procedure; and
receiving, from the second DU, a third message in response to the second message,
wherein the T-MCG is configured by exchanging the second message and the third message, and at least one of the second message or the third message includes information element(s) required for configuring the T-MCG.

19. The method according to claim 16, further comprising: receiving, from the second DU, a fourth message indicating that the inter-cell mobility procedure is completed, wherein the inter-cell mobility procedure is triggered by the first DU.

20. The method according to claim 16, further comprising:
transmitting, to the CN, a fifth message requesting switching from a path between a core network (CN) and the first CU to a path between the CN and the second CU; and
receiving, from the CN, a sixth message in response to the sixth message.
